(19) United States
(12) Patent Application Publication
(10) Pub. No.: US 2014/0324615 A1
(43) Pub. Date: Oct. 30, 2014

(54) SYSTEMS, METHODS, AND DEVICES FOR PROVIDING A RETAIL STORE PLATFORM FOR INTERACTING WITH SHOPPERS IN REAL-TIME

(71) Applicants: Raghavendra Kulkarni, Fremont, CA (US); Shirish Patel, Palo Alto, CA (US); Santanu Das, Monroe, CT (US)

(72) Inventors: Raghavendra Kulkarni, Fremont, CA (US); Shirish Patel, Palo Alto, CA (US); Santanu Das, Monroe, CT (US)

(73) Assignee: README SYSTEMS, INC., Palo Alto, CA (US)

(21) Appl. No.: 14/072,750

(22) Filed: Nov. 5, 2013

Related U.S. Application Data
(60) Provisional application No. 61/815,935, filed on Apr. 25, 2013.
(60) Provisional application No. 61/834,352, filed on Jun. 12, 2013.

(51) Int. Cl. G06Q 30/06; H04W 8/14

(52) U.S. Cl. CPC G06Q 30/0601; H04W 8/14
USPC 705/26.1

(57) ABSTRACT

Systems, methods, and devices for providing a store platform for interacting with shoppers in real time are disclosed. The platform is based on a combination of wireless-enabled sensors located strategically in retail stores and computer servers. The computer may be local, remote, or in a cloud. The sensors are used to ‘scan’ the presence of shoppers in front of products in retail aisles and the computer servers ‘analyze’ the shoppers' profile based on pre-stored and newly-sensed information. The analyzed profiles are used to ‘connect’ with shoppers in real time and push electronic incentives and product information to shoppers' mobile devices. The ‘sensed’ information, in conjunction with the pre-stored data, is also used to update the shoppers' profile and generate analytics related to shopper behavior, brand loyalty, etc.

### CROSS-REFERENCE TO RELATED APPLICATIONS

The present application claims benefit under the US law and rules including 35 U.S.C. §119(e) from U.S. Provisional Patent Application Ser. No. 61/815,935 filed on Apr. 25, 2013 the entire contents of which is being incorporated herein by reference.

The present application claims benefit under the US law and rules including 35 U.S.C. §119(e) from U.S. Provisional Patent Application Ser. No. 61/834,352 filed on Jun. 12, 2013 the entire contents of which is being incorporated herein by reference.

The present application is related to U.S. patent application Ser. No. ______ (Techlaw Docket No. 13-090-A) titled “Systems, Methods, and Devices for Providing a Retail Store Platform For Interacting with Shoppers in Real-Time” filed herewith and the entire contents of which is being incorporated by reference.

### BACKGROUND OF THE INVENTION

In the current market landscape, 70% of shoppers are making retail buying decisions in front of products in retailers' aisles. Such a decision process has been coined by leading Consumer Product Group (CPG) Company Proctor & Gamble (P&G) to be a “First Moment of Truth”, and is defined to be the brief time period from the time when a consumer encounters branded product to the time in which to influence the purchase the consumer's decision to purchase the branded product. CPG companies are on a quest to find new ways to market themselves to shoppers during the First Moment of Truth to influence their purchasing decisions in real time and to generate brand awareness using packaging of a product, display of a product, incentives, brand loyalty, new product introduction, product information, shopper surveys as well as other mechanisms.

Hence, for more effectiveness, there is a need for a retail store system platform for interacting with shoppers in real time for influencing purchasing decisions and to generate brand awareness when shoppers are in front of products in retailer aisles during the “First Moment of Truth.”

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a functional block diagram of a system providing a retail store platform for interacting with shoppers in real time in accordance with some embodiments.

FIGS. 2-5 are functional block diagrams of devices used in a system providing a retail store platform for interacting with shoppers in real time in accordance with some embodiments.

FIGS. 6-11 are flowcharts of methods for providing a retail store platform for interacting with shoppers in real time in accordance with some embodiments.

FIG. 12 is a functional block diagram of a system providing a retail store platform for interacting with shoppers in real time in accordance with some embodiments.

FIG. 13 is a functional block diagram of a system providing a retail store platform for interacting with shoppers in real time in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Systems, methods, and devices for providing a retail store platform for interacting with shoppers in real time are disclosed. Embodiments include the platform being based on a combination of wireless-enabled sensors located strategically in retail stores and one or more computer servers placed locally, remotely, or in a cloud. Wireless-enabled sensors are used to detect the presence of shoppers' wireless mobile devices at various points in the retail store, in front of products in retail aisles and other points such as entry and exit points and checkout counters. The system captures the shoppers' profile based on among other things, a Media Access Control (MAC) identifier and/or Universally Unique Identifier (UUID) of shopper's mobile devices. Any combination of MAC identifier or a UUID is a device identifier for a shopper's wireless mobile device. The computer servers receive and analyze the shoppers' profiles based on pre-stored and newly sensed (i.e. acquired by the wireless-enabled sensors) information. The analyzed profiles are used to connect with shoppers in real time to push coupons, incentives, product information, etc., to the shoppers' wireless mobile devices. The sensed information, in conjunction with the pre-stored data, is also used to generate or update the shoppers' profiles and generate analytics related to shopper behavior, brand loyalty, etc.

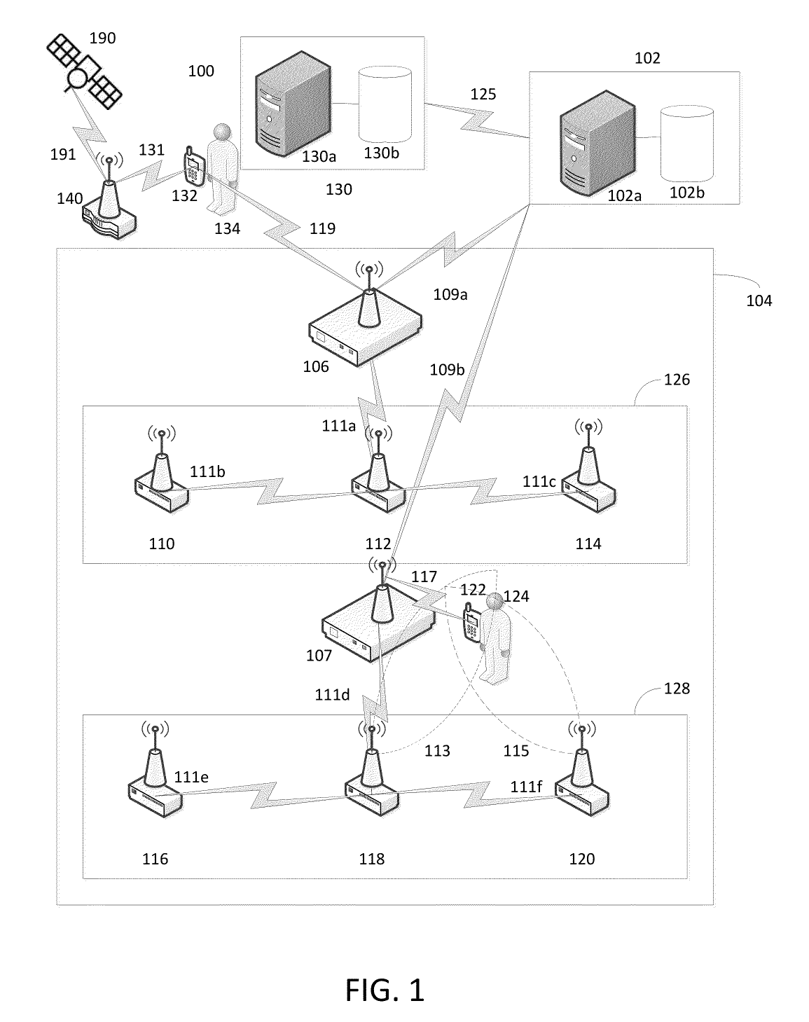

FIG. 1 is a functional block diagram of a system 100 providing a retail store platform for interacting with shoppers in real time in accordance with some embodiments. The system 100 includes gateway sensor nodes (106-107) and a set of data sensors (110-120) that comprise a sensor network located throughout a retail store 104. Some of the data sensors (110-114) may be located in one aisle 126 while some other data sensors (116-120) may be located in another aisle 128 of many such aisles in the retail store 104. The data sensors (110-120) are coupled to the set of gateway sensors nodes (106-107) over one or more communication networks (111a-111d). In one embodiment, the data sensor 112 is coupled to the gateway sensor node 106 and data sensors 110 and 114. Any communication between gateway sensor node 106 to either data sensor 110 and data sensor 114 is relayed by data sensor 112. Analogously, data sensor 118 is coupled to the gateway sensor node 107 and data sensors 116 and 120. Any communication from the gateway sensor node 107 to either data sensor 116 and data sensor 120 is relayed by data sensor 118. In other embodiments, each data sensor (110-120) may be coupled to gateway sensor nodes individually over a communication network or coupled to the gateway sensor nodes in a star or mesh communication network. In some embodiments such a communication network (111a-111d) may be a wireless network while in other embodiments the communication network may be a land-line network. In some embodiment, the data sensors (110-120) are coupled to the gateways sensors nodes using a WiFi network while in other embodiments the data sensors (110-120) are coupled to the gateways sensors using an Industrial, Scientific, Medical (ISM) protocol (operating at 902-928 MHz, and all ISM bands ranging from 433 MHz to 5.8 GHz, radio can be ultra wideband, chirp, and narrowband type) over a communication network.

Each data sensor (110-120) may be located in an aisle (126-128) of the retail store 104 near one or more retail products shelved in the aisle (126-128). Further, each data sensor (110-120) may be provisioned such that it is associated with the one or more retail product display in the aisle (126-128) as described in the present disclosure. In addition, each gateways sensor node (106-107) may be attached or placed in the walls or ceilings of the retail store 104 or any location that can be conducive to be coupled to a subset of the data sensors (110-120) and the primary computer server 102. In some embodiments, medium size retail store may have 80 sensors and one gateways sensor node.

Further, the gateway sensor nodes (106-107) may be coupled to one or more primary computer server system 102) over one or more communication networks (109a-109b). The primary computer server system may include one or more primary computer server 102a and a primary database 102b. In the present disclosure, a computer server may, but not always, refer to embodiments that include a computer server system having one or more computer servers and one or more databases coupled to each other. The one or more computer servers may be co-located with each other or distributed among different locations. Likewise, the one or more one or more databases may be co-located with each other or distributed among different locations. In further embodiments, some of the one or more computer servers may be co-located and coupled to the one or more databases while in additional embodiments some of the one or more computer servers may be coupled to the one or more databases each of which are placed in different location. In still further embodiments, a computer server system may refer to at least one of a computer server and a database.

Further, the communication networks (109a and 109b) coupling the one or more gateways sensor nodes to the primary computer server (system) 102 may be, but not limited to, a wireless network, landline network, local area network (LAN), wide area network (WAN), satellite network, WiFi, and Internet. Further, the primary computer server (system) 102 may be coupled to secondary computer server system 130 over another communication network or a direct link 125. As with other embodiments that include a computer server, a secondary computer server may refer, in some embodiments, to a secondary computer server system that include one or more secondary computer servers 130a coupled to one or more secondary databases 130b. The communication network 125 may be but not limited to, a wireless network, landline network, local area network (LAN), wide area network (WAN), satellite network, WiFi, and Internet.

Moreover, the system 100 includes at least one calibration sensor 140 coupled to a global position system (GPS) 190 over a communication network 191. Such a communication network may be a satellite communication network. In other embodiments, the calibration sensor 140 may be coupled over one or more communication networks to one or more cellular base stations coupled to a GPS system.

### Providing Electronic Incentives Based on Shopper Behavior

As the shopper 124 enters the retail store 104, the one or more gateway sensor nodes (106-107) are configured to detect the wireless mobile device 122 dynamically over a wireless communication network 117 (e.g. WiFi). Further, the gateway sensor nodes (106-107) query and collect a media access control (MAC) identifier (i.e. address) from the wireless mobile device 122 and records a timestamp. The MAC identifier may be a unique 12 or 16 character (hexadecimal) identifier associated with the wireless mobile device. The timestamp may be a sequence of characters or encoded information identifying when a certain event occurred by giving a date and time of day for the event or by recording a time interval from a reference date. Upon receipt, the one or more gateways sensor nodes (106-107) transmit the timestamp and the MAC identifier of the wireless mobile device 122 to the primary computer server 102 over the communication network 109b for storing and processing.

Further, the one or more gateways sensor nodes (106-107) transmit, on request from shopper, a network connectivity offer notification as well as a request for shopper profile information and tag module download offer notification to the wireless mobile device 122. Network connectivity allows the shopper 124 access (through a wireless (e.g. WiFi) network 117) to the Internet using the wireless mobile device 122. Thus, upon acceptance of the network connectivity offer, the wireless mobile device 122 may be coupled to the gateways sensor nodes (106-107) over the wireless network 117 (e.g. WiFi). Further, the gateway sensor nodes (106-107) may request the shopper 124 for the shopper profile information to be sent to the primary computer server to determine whether the shopper is a new customer or a previous customer. The shopper profile information may be stored in the primary database 102a and accessed based on a store loyalty card number or other information provided by the shopper 124 through the wireless mobile device 122 or using the possible combination of MAC ID, timestamps, proximity data, power level in dBm, location data etc., collected by the sensor network.

In addition, the one or more gateways sensor nodes (106-107) offers the shopper 124, while accepting the network connectivity, to download a tag module allowing the shopper 124 to receive purchase incentives. The tag module may include a wireless application to be downloaded to the wireless mobile device 122. Moreover, the one or more gateways sensor nodes (106-107) may receive (affirmative) instructions in response to the tag module download offer from the wireless mobile device 122 to couple the wireless mobile device 122 to the wireless communication network 117 and to download a tag module. Upon receiving the instructions, the one or more gateways sensors nodes (106-107), in cooperation with the primary computer server 102, transmit a link to an application repository (e.g. Apple App Store, Android App Store, Windows App Store, Third party repositories, etc.) for downloading the tag module to the wireless mobile device 122 such that the wireless mobile device 122 can now be discerned as a “tagged” wireless mobile device because the wireless mobile device can now implement the tag module.

In a further embodiment, the data sensors (110-120) may be coupled to the one or more gateways sensor nodes (106-107) over a wireless communication network (111a-111f). Further, each data sensor (110-120) has at least one processor, at least one memory or electronic storage device, and a MAC identifier stored in such a memory device. In addition, each data sensor (110-120) may generate one or more personal communication networks (e.g. personal area networks (PANs) for Bluetooth connections), (113 and 115) using a directional antenna. Moreover, each data sensor (110-120) is configured to detect the tagged wireless mobile device 122 over one or more personal communication networks (113 and 115), which is based on Bluetooth Low Energy (BLE) or Bluetooth Smart/WiFi technology, and to request and receive the MAC identifier from the tagged wireless mobile device. Further, each of the data sensors (110-120) is configured to transmit the MAC identifier of the tagged wireless mobile device, the MAC identifier of data sensor to the primary computer server 102 through the one or more gateways sensor nodes (106-107) and one or more communication networks (111a-111f, 109a-109b). In such embodiments, the data sensors (110-120) can collect the MAC ID (or UUID) of a shopper's mobile phone (e.g. smartphone or legacy phone) using a personal communication network and this device identifier (device ID) information can be combined with other information (e.g. shopper information, shopper loyalty information, etc.) to generate a Unique User Binding; that is, the device identifier (MAC ID or UUID) is at least associated with a shopper's identity information.

The system 100 includes a data sensor 120 coupled to the gateway sensor node 107 over communication network (111a-111f). Such a data sensor 120 may be in a location or position to provide electronic product information and/or electronic product purchase incentive because of its location or association with a particular product for which there may be a promotion. Such a data sensor 120, herein called an incentive data sensor, has a MAC identifier stored in a memory device and a processor and generates a corresponding personal communication network 115 (like any other of the data sensors (110-120)). Further, the incentive data sensor is configured to detect the tagged wireless mobile device 122 over the personal communication network 115 and determine that the tagged wireless mobile device is in communication with the data sensor exceeding a predetermined threshold of time period. That is, a shopper 124 may be browsing products throughout the aisles (126-128) of the retail store 104 for possible purchases. The owner and operator of system 100 may have knowledge that a shopper who stops in front of a product between 5-7 seconds is contemplating a purchase (i.e. “First Moment of Truth”). Thus, the predetermined threshold of time period may be configured to be 5 seconds. When the predetermined threshold of time has been exceeded, then the incentive data sensor 120 may request and receive the MAC identifier from the tagged wireless mobile device 122 and transmit the MAC identifier of the tagged wireless mobile device, the MAC identifier of the incentive data sensor 120 to the one or more computer servers through the one or more gateway sensor nodes over a communication network. Note that an incentive data sensor may be any data sensor in the system 100. Further, in some embodiments, no electronic product purchase incentive is transmitted to a tagged wireless mobile device even though the predetermined threshold of time has been exceeded.

The primary computer server 102 processes the information received from the incentive data sensor 120 including the MAC identifier of the tagged wireless mobile device 122 and the MAC identifier of the incentive data sensor 120. The primary computer server 102 include a primary databases 102 b and looks up shopper 124 information based on the MAC identifier of the tagged wireless mobile device 122. Moreover, the primary computer server 102 may look up the product on the aisle 128 associated with the MAC identifier of the incentive data sensor 120. Upon processing the information received from the incentive data sensor 120 (including looking up the product associated with the incentive data sensor 120), the primary computer server 102 may provide instructions, product information, and an electronic product purchase incentive to the incentive data sensor 120. The electronic product purchase incentive may be an electronic coupon, rebate, discount, promotion, or any other incentive redeemable at a point-of-sale (POS) terminal that may persuade the shopper 124 to purchase the product associated with the incentive data sensor 120.

Further, the incentive data sensor 120 may receive at least one of one or more instructions, product information and electronic product purchase incentive from the primary computer server 102 and transmits a notification requesting interaction with the tagged wireless mobile device 122 that includes a notification of an offer of the electronic product purchase incentive ready to be sent to the tagged wireless mobile device 122. When the tagged wireless mobile device 122 receives the notification, the shopper 124 may input an affirmation to have the tagged wireless mobile device interact with the primary computer server 102 through either a gateway sensor 107 or incentive data sensor 120. Moreover, the incentive data sensor 120 receives one or more instructions from the tagged wireless mobile device to transmit the electronic product purchase incentive to the tagged wireless mobile device 122. In some embodiment, the electronic product purchase incentive can be sent by the primary server to the ‘tagged’ mobile device using text messaging, Short Messaging Service (SMS), and/or Multimedia Messaging Service (MMS), in cooperation with a carrier of the mobile phone or some other third-party service provider. (In the present disclosure, the terms carrier and third party provider may be used interchangeably). In further embodiments, a HyperText Transfer Protocol (HTTP) (or any other communication, e.g. email) session between the server of the service provider, who owns the retail store, and the tagged wireless mobile device can be also used to download product incentive information and also to support interaction between the shopper and the server in real-time when the shopper is in the store. Such a communication scenario may be considered a communication session.

In one embodiment, each of the first set of data sensors and the incentive data sensor includes one or more batteries to provide power to a corresponding data sensor and that the corresponding data sensor receives one or more power duty cycling commands to conserve power from the one or more gateways sensor nodes. The power duty cycling commands include a sleep command and a wake command such that the corresponding data sensor has a power duty cycle of a power duty time period, a sleep time period that is a portion of the power duty time period, and an awake time period that is a portion of the power duty time period.

### Predictive Pushing of Electronic Incentives

In a second set of embodiments, the system 100 tracks the shopper 124 browsing through the aisles (126 and 128) of the retail store 104. Based on the products the shopper is browsing, the system 100 may provide the shopper 124 with an electronic product purchase incentive for a product at a location the shopper may be (predictively) browsing in the near future. In such an embodiment, the system 100 includes a primary computer server 102 having a primary database 102b storing customer data, retailer information, product information including one or more electronic product purchase incentives in computer (electronic) media. In addition, the one or more gateway sensor nodes (106-107) are coupled to the primary computer server 102 using the communication network (109a-109b). Moreover, the gateway sensor node (106-107) may be coupled to the one or more data sensors (110-120) over a wireless communication network (111a-111f) (e.g. ISM).

Each of the data sensors (110-120) may have a processor, a memory device and retail product identifier stored on the memory device. Further, each of the data sensors may generate a corresponding personal communication network using a directional antenna (113 and 115). In addition, each data sensor (e.g. 116 and 118) is configured to detect a tagged wireless mobile device 122 over the one or more personal communication networks. The tagging of the wireless mobile device is done dynamically as described herein. Moreover, each data sensor (e.g. 118 and 120) collect timestamp and MAC identifier of the tagged wireless mobile device 122 and transmits the timestamp and MAC identifier of tagged wireless mobile device 122 as well as the MAC identifier and/or retail product identifier of each data sensor (e.g. 118 and 120) to the primary computer server 102 (via communication network (111d, 111f), gateway sensor node 107, and communication network 109b).

Further, the primary computer server 102 receives timestamp, MAC identifier of the tagged wireless mobile device 122 as well as the MAC identifier and/or retail product identifier from each data sensor (e.g. 118 and 120) in communication with the tagged wireless mobile device and updates the primary database 102b accordingly. In addition, the primary computer server 102 processes the retail product identifier information (by either receiving the retail product identifier from the data sensors (118, 120) or by access the retail product information based on the retail product identifier and/or MAC identifier of the data sensors (118, 120) associated with each data sensor (e.g. 118, 120) and generate an electronic product purchase incentive. Moreover, the primary computer server 102 receive the timestamp and MAC identifier of the tagged wireless mobile device 122 from a second set of data sensors (e.g. 118) as well as the MAC identifier of each of the second set of data sensors (e.g. 118). Further, the one or more primary computer servers may determine the past and present location of the tagged wireless mobile device 122 based on the processing the received MAC identifier of each of the second data sensors (e.g. 118). That is, the primary computer server 102 may have generated a store map a priori recording the location of each data sensor (110-120) in the retail store 104 based on the MAC identifier of each data sensor (110-120). Upon receiving the MAC identifier of each of the second set of data sensors (e.g. 118), the primary computer server 102 can then determine the past or present location of the tagged wireless mobile device 122. In addition, the primary computer server 102 may determine a next location of the tagged wireless mobile device 122 based on determining the past and present location of the tagged wireless mobile device 122. Moreover, the primary computer server 102 transmits the electronic product purchase incentive notification to a data sensor or a gateway sensor 107 closest to the next location of the wireless mobile device (e.g. 116).

Further, such a data sensor (e.g. 116) is configured to detect the tagged wireless mobile device 122 and determine that the tagged wireless mobile device has been present within the range of its personal communication network exceeding a pre-configured threshold of time (e.g. “First Moment of Truth”). If so, the data sensor (e.g. 116) or a gateways sensor 107 transmits the electronic product purchase incentive to the tagged wireless mobiles device 122 and may further request the shopper 124 to download additional product and retail store information to the tagged wireless mobile device 122.

### Provisioning Data Sensors and Generating a Store Map

In a third set of embodiments, retail store personnel may use the system 100 to generate a map of the retail store showing the locational relationship of the data sensors (110-120) and associated products with each other. Such generation of a store map may first entail provisioning each data sensor (110-120) with its associated retail product identifier. Such a provisioning procedure includes using one or more calibration sensors 140, each calibration sensor 140 having a calibration communication network 131 that dynamically couples, on demand, the calibration sensor 140 to a provisioning reader 132 having a provisioning module (e.g. mobile application). The provisioning reader may be a mobile device (e.g. smartphone, tablet computer, or any other mobile computing device) used by retail store personnel and the provisioning module includes a wireless application stored and implemented by the provisioning reader 132. In addition, the provisioning reader 132 includes a processor and a memory device that implements and stores the provisioning module, respectively. Further, the provisioning reader 132 may be coupled to the one or more gateway sensor nodes (106-107) over a wireless communication network 119 (e.g. WiFi) and may be also coupled to the one or more data sensors (110-120) over one or more personal communication networks (113-115).

Moreover, the provisioning reader can request and receive starting location information from the one or more calibration sensors 140 over the calibration communication network 131. That is, the calibration sensors 140 may be coupled to a global positioning system (GPS) 190 over one or more communication networks 191 (including a satellite network). Upon a request from the provisioning reader 132, the calibration sensor 140 provides the location information of the calibration sensor 140 to the provisioning reader 132 while the provisioning reader 132 is in detection proximity of the one or more calibration sensors. Such a calibration sensor 140 may be placed near an entrance or exit of the retail store 104 to provide better reception of the location information from the GPS system 190.

After receiving the starting location information from the calibration sensor 140, the retail store personnel 134 may travel along the aisles (126-128) of the retail store 104 to provision product information onto the one or more data sensors (110-120) using the provisioning reader 132. Such provisioning includes the provisioning reader 132 requesting and receiving a media access channel (MAC) identifier from each of the one or more data sensors (110-120). Further, the provisioning reader 132 determines a current location of the provisioning reader 132 based on the processing of the starting location information received from the one or more calibration sensors 130 and calculates data sensor location based on the current location of the provisioning reader 132. That is, as the retail store personnel with the provisioning reader 132 is positioned in front of a data sensor, the provisioning reader 132 has technology known in the art (e.g. accelerometer, etc.) to determine its current location with respect to the starting location provided by the calibration sensor 132 while the provisioning reader is in detection proximity of the data sensor. In addition, the provisioning reader 132 stores the retail product identifier, MAC identifier of each data sensor, and data sensor location for each data sensor on the memory device of the provisioning reader 132 and further transmits the retail product identifier, MAC address, and data sensor location for each of the one or more data sensors to the primary computer server 102, over the wireless communication network 119 (e.g. WiFi), the one or more gateway sensor nodes (106-107) and another communication network (109a-109b).

Further, the primary computer server 102 dynamically generates a store map based on the received data sensor location and corresponding product identifier and MAC identifier of each data sensor (110-120). Such a store map can be used by the primary computer server 102 to determine past, present, and future locations of shoppers contemplating product purchases and provide electronic product purchase incentives at the future locations to persuade shopper to purchase products. Further, this information can be used to generate a humidity or temperature map of the store to be used to manage store inventory on retail store aisles (1260128). In such an embodiment, data sensors, gateways sensor nodes and any other sensor described herein may include temperature and humidity meters (i.e. sensors). The temperature and humidity sensors may record ambient temperature and humidity and provide such information to the primary computer server 102 to periodically update the humidity or temperature map to manage store inventory.

### Retail Partner Providing Electronic Incentives

In a fourth set of embodiments, the system 100 allows for a retail partner of the retail store 104 to analyze shopper behavior vis-a-vis partner's product shelved in the retail store 104 and provide product information and/or electronic product purchase incentives. The retail partner may be a manufacturer or distributer of a product or a third party that analyzes data for a retail partner or the retail store 104 itself.

In such embodiments, the system 100 includes a secondary computer server (system) 130 that may be used for generating analytics and providing product information and/or electronic product purchase incentives on behalf of a retail partner of the retail store 104. For example, a beverage manufacturer may be provided with information that the shopper 124 has browsed the aisle displaying snacks. The beverage manufacturer may want to provide the shopper 124 with an electronic product purchase incentive that may persuade the shopper 124 to purchase a beverage sold by the beverage manufacturer to complement a possible purchase of snacks.

Such embodiments may include a primary computer server 102 corresponding to the retailer coupled to a secondary computer server 130 associated with the retailer partner (i.e. a beverage manufacturer) over communication network 125. Further, a first set of data sensors (118, 120) detects a tagged wireless mobile device 122 over WiFi and the one or more personal communication networks (113, 115) and collects at least one of the timestamp, UUID and MAC identifier of the tagged wireless mobile device 122. In addition, each data sensor of the first set of data sensors (118, 120) transmits timestamp and MAC identifier of tagged wireless mobile device 122 as well as the MAC identifier and/or the retail product identifier of each data sensor of the first set of data sensors (118, 120) to the primary computer server 102.

Moreover, the primary computer server 102 receives timestamp, MAC identifier of the tagged wireless mobile device 122 as well as the MAC identifier and/or retail product identifier from each data sensor (118, 120) in communication with the tagged wireless mobile device 122. Further, the primary database 102b is updated accordingly. In addition, the primary computer server 102 processes the retail product identifier (either received from the data sensors (118, 120) or accessed from primary database 102b based on the MAC identifier of the data sensors (118, 120) to generate the retail product information and transmits the retail product information and the shopper information (accessed from the primary database 102b based on the MAC identifier of the tagged wireless mobile device 122) to the secondary computer server 130.

The secondary computer server 130 receives the processed product information and updates the secondary database 130b based on the received information. Further, the secondary computer server 130 processes the product information and may generate a secondary purchase incentive and analytics based on the processed product information. The secondary computer server 130 may transmit the secondary purchase incentive to the primary computer server 102.

Moreover, the primary computer server 102 receives the secondary purchase incentive and receive timestamp and MAC identifier of the tagged wireless mobile device 122 from a second set of data sensors (118) and receive the product identifier for each of the second set of data sensors (118). Further, the primary computer server 102 determines a next location of the tagged wireless mobile device 122 based on the received timestamp and MAC identifier of the tagged wireless mobile device 122 and the product identifier for each of the second set of data sensors (118). In addition, the primary computer server 102 transmits the secondary purchase incentive notification to a data sensor (116) or a gateways sensor 107 closest to the next location of the tagged wireless mobile device 122 as described herein.

The data sensor 116 detects the wireless mobile device and the computer server 102 transmits the secondary purchase incentive to the tagged wireless mobiles device 122 if the tagged wireless mobile device 122 is detected to be within the range of the data sensor's personal communication network for a time exceeding a predetermined threshold.

In some embodiments, the secondary server (and secondary database) (130,130a, 130b) may be owned or operated by product partners or loyalty partners of the retailer. Other embodiments may have the secondary server (and secondary database) (130,130a, 130b) be owned or operated by a ratings or global information measurement company (e.g. Nielsen).

In some embodiments, a service provider that provides the data sensors (110-120), gateways sensor nodes (106-107), calibration sensor 130 and provisioning reader 132 may have a business model that includes charging a fixed monthly recurring fee per sensor (106-107,110-120, 130) bundled in various configurations. Further, for an additional fee, the system provider generates and shares different analytics for the retail store 104 based on data (e.g. terabytes of data per day) collected regarding shopper behavior by the sensors (106-107,110-120, 130). Another business model may be to charge a one-time purchase price for the sensors and other system 100 components in addition to a yearly maintenance fee. A further business model may include charging a one-time Set Up fee for the system 100 and have a revenue sharing arrangement with the retailer such that retailer shares a percentage of revenue based on transactions and the nature of transactions using the system 100 with the system 100 provider. Embodiments may include a combination of different such business models.

The communication networks described with respect to FIG. 1 (and in the present disclosure generally) may be, but not limited to, a wireless network (cellular, Bluetooth, WiFi), landline network, local area network (LAN), wide area network (WAN), satellite network, ISM (Industrial, Scientific, and Medical—Frequencies allocated in 433 MHz-5.8 GHz for FCC 47 CFR Part 15.5) and Internet.

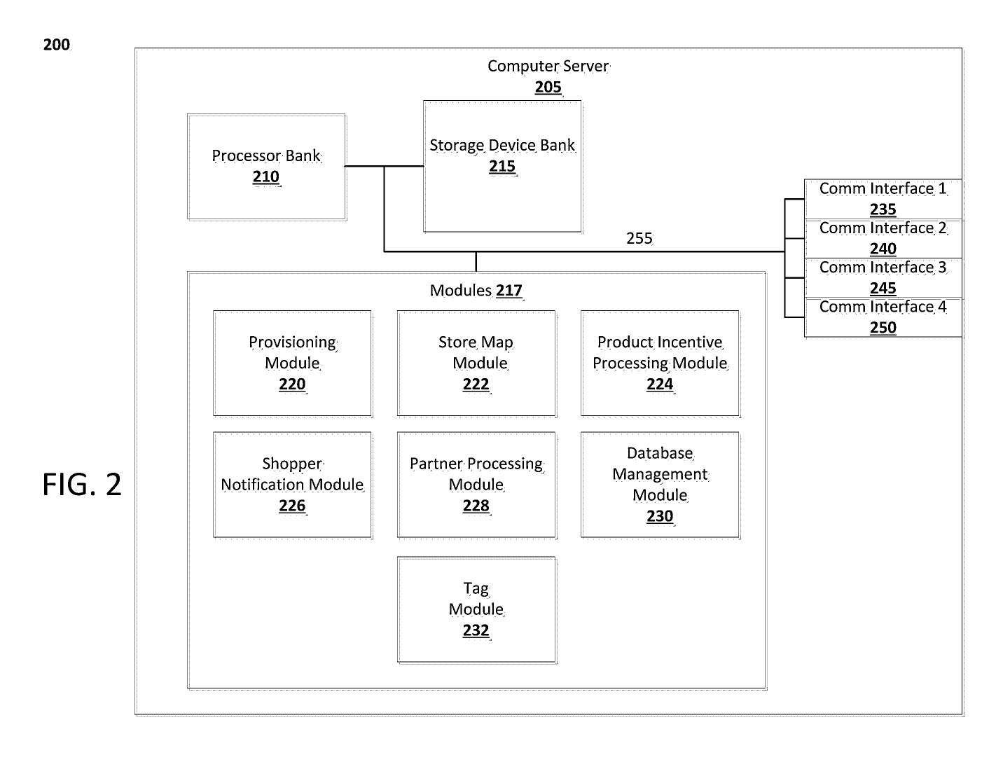

FIG. 2 is a functional block diagram of a computer server 205 used in a system providing a retail store platform for interacting with shoppers in real time in accordance with some embodiments. Such a computer server 205 may be used in a system shown in FIG. 1. The computer server 205 may include several different components such as a processor bank 210, storage device bank 215, one or more software applications, which may be executed by a processor to form specifically-configured module devices 217, and one or more communication interfaces (235-250). The processor bank 210 may include one or more processors that may be co-located with each other or may be located in different parts of the computer server 205. The storage device bank 215 may include one or more storage devices. Types of storage devices may include memory devices, electronic memory, optical memory, and removable storage media. The one or more modules 217 may include a provisioning module 220, store map module 222, a product incentive processing module 224, shopper notification module 226, partner processing module 228, a database management module 230, and a tagging module 232. The modules 217 may be implemented by the one or more processors in the processor bank 210.

The computer server 205 may include a database stored in the storage device bank 215 or may be coupled to a database. Further, computer server 205 may be part of a computer server system described herein that may include one or more computer servers and one or more databases. In the present disclosure, a computer server may, but not always, refer to embodiments that include a computer server system having one or more computer servers and one or more databases coupled to each other. The one or more computer servers may be co-located with each other or distributed among different locations. Likewise, the one or more one or more databases may be co-located with each other or distributed among different locations. In further embodiments, some of the one or more computer servers may be co-located and coupled to the one or more databases while in additional embodiments some of the one or more computer servers may be coupled to the one or more databases each of which are placed in different location. In still further embodiments, a computer server system may refer to at least one of a computer server and a database.

The provisioning module 220 may be used in a set of embodiments to provision a retail product identifier to each of a set of data sensors placed throughout a retail store and such retail product identifiers, MAC identifiers, and/or UUID and location of each of the set of data sensors are provided to the computer server 205 to generate a store map accordingly. In one embodiment, the provisioning module 220 receives a MAC identifier and a retail product identifier as well as a location associated with a data sensor from a provisioning reader. That is, retail store personnel may use a provisioning reader described herein to provision a retail product identifier to each data sensor located within a retail store. Further, the provisioning reader may record the timestamp associated with provisioning of a data sensor. In addition, a provisioning reader may determine (as described herein) and store a location of the data sensor. Moreover, the provisioning reader may transmit the MAC identifier and the retail product identifier as well as the location associated with each data sensor to the computer server 205. The provisioning module 220 may process MAC identifier and the retail product identifier as well as the location associated with each data sensor and provide the processed information to the store map module 222.

In addition, the store map module 222 receives the processed information from the provisioning module 220 and generates a store map that includes mapping of each data sensor with its retail product identifier, MAC identifier, and location. Further, the store map module 222 may be used to provide incentives in some embodiments. That is, the store map module 222 may receive requests from other modules to determine past, present, and future location of a shopper's tagged wireless mobile device based on data sensor MAC identifier, retail product identifier and location. The store map module 222 may provide the MAC identifier, retail product identifier and data sensor location to the other modules such that the other modules can generate and provide product information and/or an electronic product purchase incentive to a shopper.

In embodiments that provide a tag module to a shopper wireless mobile device described herein, the shopper notification module 226 provides (via a one or more communication networks and a gateway sensor node) a notification offering a shopper to download a tag module to a wireless mobile device to receive electronic product purchase incentives redeemable at the retail store POS terminal.

In some embodiments, a POS system (that includes a POS terminal) may be used to associate a shopper's identity information with a mobile device identifier (e.g. MAC ID, UUID) by having the POS system coupled to the primary server. In such an embodiment, the POS terminal may redeem a coupon from the shopper's wireless mobile device. The POS terminal also provides the redeemed coupon information to the primary server such that the primary server may then access the shopper identity information and the device identifier (e.g. MAC ID, UUID) based on the redeemed coupon information (a priori, the primary computer server records coupons sent to the shopper's wireless mobile device and associates sent coupons with the shopper's identity information). The primary server may then provide the shopper's identity information and the device identifier to the POS terminal. The POS system may then associate the device identifier with the shopper identifier information and provide it to other retail servers. In another embodiment, a data sensor co-located with and coupled to the POS terminal may obtain the device identifier (e.g. MAC ID, UUID) from the shopper's wireless mobile device and provide the device identifier to the POS terminal. The POS terminal can now validate and associate device identifier received from the primary server with the device identifier from the data sensor by communicating with the primary server through the data sensor (so that the device associated with the coupon has been used to redeem).

In another embodiment, a shopper may render payment for a purchase at a POS terminal. A data sensor co-located with and coupled to the POS terminal may obtain the device identifier (e.g. MAC ID, UUID) from the shopper's wireless mobile device and provide the device identifier to the POS terminal. Further, the POS terminal may receive shopper identity information (e.g. credit card information, address, mobile telephone number, store loyalty information, etc.) from the shopper at the point-of sale (through shopper input or store cashier input). The POS system may then associate the device identifier with the shopper identifier information and provide it to the primary server or other retail servers.

In such embodiments, the data sensors (110-120) can collect the MAC ID (or UUID) of a shopper's mobile phone (e.g. smartphone or legacy phone) using a personal communication network and this device identity information can be combined with other information (e.g. shopper information, shopper loyalty information, etc.). to generate a Unique User Binding; that is, the device identifier (MAC ID or UUID) is at least associated with a shopper's identity information.

If the shopper affirmatively replies to the offer of downloading the tag module, a copy of the tag module 232 stored in the storage device bank 215 is transmitted by the computer server 205 to a shopper's wireless mobile device. Such a wireless mobile device is discerned to be a “tagged” wireless mobile device. In other embodiments, the shopper notification module 226 sends (via a one or more communication networks and a gateway sensor node) to the tagged wireless mobile device a notification offering a shopper one or more electronic product purchase incentives to persuade the shopper to purchase specific products. Such notifications may cause corresponding alerts to be displayed on the shopper wireless mobile device.

The product incentive processing module 224 may be used in some embodiments to generate and provide and electronic product purchase incentive to a shopper. In such embodiments, the product incentive processing module 224 may process MAC identifier and timestamp of a tagged wireless device received from a set of data sensors. Further, the product incentive processing module 224 may receive the MAC identifier and/or retail product identifier associated with each of the set of data sensors. The product incentive processing module 224 may process such information as well as access stored shopper information in database based on the MAC identifier of the tagged wireless mobile device. Shopper information may include past purchases made by the shopper as well as times the shopper browsed a product for a time exceeding a predetermined threshold (i.e. “First Moment of Truth”). Based on the shopper information and the received information from each of the set of data sensors, the product incentive processing module 224 may generate product information and/or an electronic product purchase incentive to be downloaded or transmitted to the shopper's tagged wireless mobile devices through one or more communication networks, gateway sensor nodes, and a data sensor as described herein.

The partner processing module 228 may be used in embodiments of computer server 205 such that computer server 205 is owned, operated, or otherwise associated with a partner of the retail store. Further, the partner processing module 228 may be used to process information received from data sensors to generate and provide a secondary product information and/or secondary product purchase incentive to the tagged wireless mobile device as described herein. In such embodiments, the partner processing module 228 may receive and process MAC identifier and timestamp associated with a tagged wireless device received from a set of data sensors. Further, the partner processing module 228 may receive the MAC identifier and/or retail product identifier associated with each of the set of data sensors. Based on such information, the partner processing module 228 may process such information as well as access stored shopper information in a secondary database coupled to, or stored in the computer server 205 based on the MAC identifier of the tagged wireless mobile device. Shopper information may include past purchases of the partner's products made by the shopper as well as times the shopper browsed a partner's product for a time exceeding a predetermined threshold (i.e. “First Moment of Truth”). Based on the shopper information as well as the information received from each of the set of data sensors, the partner processing module 228 may generate a secondary product information and/or secondary product purchase incentive to be downloaded or transmitted to the shopper's tagged wireless mobile devices through one or more communication networks, a gateways sensor node, and a data sensor as described herein.

The database management module 230 updates the database coupled to or stored in the computer server with information received from the shopper wireless mobile device and/or data sensors. In some embodiments, the database management module 230 receives information from one or more data sensors that include MAC identifier and timestamp of a tagged wireless mobile device as well as the MAC identifier and retail product identifier of each of the data sensors. The database management module 230 updates the database. In further embodiments, the computer server 205 may be a primary computer server such that the database management module 230 updates a primary database and if required the secondary database with received information from each of the set of data sensors.

Each of the communication interfaces (235-250) may be software or hardware associated in communicating to other devices. The communication interfaces (235-250) may be of different types that include a user interface, USB, Ethernet, WiFi, WiMax, wireless, optical, cellular, or any other communication interface coupled to a communication network. One or more of the communication interfaces (235-250) may be coupled to a user interface known in the art.

An intra-device communication link 255 between the processor bank 210, storage device bank 215, modules 217, and communication interfaces (235-250) may be one of several types that include a bus or other communication mechanism.

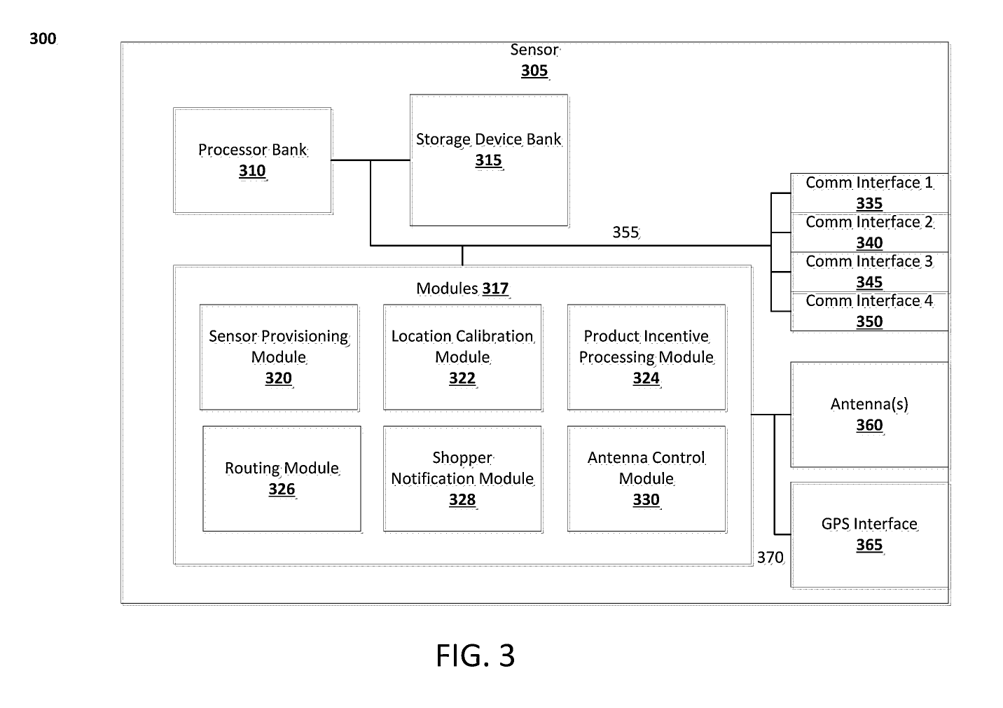

FIG. 3 is a functional block diagram of a sensor 305 used in a system providing a retail store platform for interacting with shoppers in real time in accordance with some embodiments. Such embodiments of sensor 305 may be used in a system shown in FIGS. 1, 12 and 13. That is, the embodiments of the sensor 305 may be a gateway sensor node, a data sensor node, a calibration sensor, an aisle marker sensor, or any other sensor known in the art. The sensor 305 may include several different components such as a processor bank 310, storage device bank 315, one or more software applications, which may be executed by a processor form specifically-configured module devices 317, and one or more communication interfaces (335-350). Further, the sensor 305 may include one or more directional antennas 360 and a GPS interface 365. The processor bank 310 may include one or more processors that may be co-located with each other or may be located in different parts of the sensor 305. The storage device bank 315 may include one or more storage devices. Types of storage devices may include memory devices, electronic memory, optical memory, and removable storage media. The one or more modules 317 may include a sensor provisioning module 320, location calibration module 322, a product incentive processing module 324, routing module 326, shopper notification module 328, an antenna control module 330. The modules 317 may be implemented by the one or more processors in the processor bank 310. Further, the sensor 305 may have different embodiments such as, but not limited to, a data sensor, aisle marker sensor, calibration sensor, and a gateway sensor node, that include a subset of components shown in FIG. 3.

The sensor provisioning module 320 may be used in a data sensor embodiment described herein. That is, in a data sensor embodiment, the sensor 305 may be located in an aisle in a retail store. Further, the sensor 305 may be provisioned such that the sensor 305 is associated with one or more products. In such a data sensor embodiment, the sensor provisioning module 320 receives retail product identifier information from a provisioning reader. The retail product identifier information is stored in the storage device bank 315 to be accessed in the future and transmitted to a primary computers server. Further, the sensor provisioning module 320 may provide the provisioning reader with the MAC identifier of the sensor 305 to be transmitted to the primary computer server (along with the product identifier) for the primary computer to generate store map described herein.

The location calibration module 322 may be used in a calibration sensor embodiment described herein. In such a calibration sensor embodiment, the location calibration module 322 communicates with a GPS system over the GPS interface 365 to receive location information. Such location information received from the GPS system may include geographic information or address information (e.g. altitude, longitude, and latitude as well as street address information). The location calibration module 322 may store such information in the storage device bank 315 as well provide such information to a provisioning reader to determine and provision data sensors with data sensor location.

The product incentive processing module 324 may be used in a data sensor embodiment described herein that provides product information and/or electronic product purchase incentive with a shopper tagged wireless mobile device. Further, the product incentive processing module 324 detects a tagged wireless mobile device and determines whether the sensor 305 has been in communication with tagged wireless mobile device exceeding a predetermined threshold of time. The predetermined threshold of time may be an average time based on historical shopper behavior information for a shopper or a group of shoppers to contemplate a purchase decision (e.g. 5 seconds).

In addition, the product incentive processing module 324 may collect MAC identifier of the tagged wireless device and record a timestamp. Moreover, the product incentive processing module 324 may access the MAC identifier of the sensor 305 and retail product identifier stored in the storage device bank 315. Further, the product incentive processing module 324 may transmit the MAC identifier received from the tagged wireless mobile device, the recorded timestamp or the MAC identifier and/or retail product identifier associated with the sensor 305.

In one embodiment, the product incentive processing module 324 may receive product information and/or an electronic product purchase incentive from a primary computer server to be transmitted to a shopper's tagged wireless mobile device. In another embodiment, after determining that the tagged wireless mobile device has been in communication with sensor 305 over a predetermined threshold of time, the product incentive processing module 324 may access an electronic product purchase incentive stored in storage device bank 315 and transmit such an electronic product purchase incentive to the shopper's tagged wireless mobile device.

The routing module 326 may be in one or more embodiments of the sensor 305 including a gateway sensor node or a data sensor described herein. The routing module 326 may be implemented when the sensor 305 receives information that is not only destined for itself but also destined for another sensor, primary computer server, or any other device. Such a sensor may be called a routing sensor. The routing module 326 may implement one or more routing methods using the processor bank 310 to generate and update routing tables as well as access one or more routing tables stored in the storage device bank 315 to route data. Based on routing table look up, the routing module 326 may transmit received information to another device over the one or more communication interfaces (335-350).

Moreover, routing module 326 may implement routing algorithms known in the art that include, but are not limited, to those algorithms described herein. Each device in the sensor network is assigned an address and a sensor 305 may implement the routing algorithms described herein to route data based on a destination address of a device in the network provided, for example, within the data. A sensor 305 may them generate and/or update routing tables based on one or more routing algorithms and route the data to a communication interface (335-350).

In one embodiment, the one or more gateway sensor nodes and the set of data sensors in a system described herein are part of a sensor network and such a sensor network includes point-to-point links between each of the one or more gateway sensor nodes, and the set of data sensors. In a further embodiment, the sensor network includes at least one master data sensor associated with one or more slave data sensors such that the at least one master data sensor routes data between the one or more gateways sensor nodes and the one or more slave data sensors. In an additional embodiment, the sensor network includes at least one master data sensor associated with, and dynamically daisy chained to, one or more slave data sensors such that the at least one master data sensor routes data between the one or more gateways sensor nodes and the one or more slave data sensors. In another embodiment, the sensor network includes the one or more gateways sensor nodes in a gateway sensor mesh network and the set of data sensors in a data sensor mesh network such that the gateways sensor mesh network and the data sensor mesh network are interconnected as well as each of the one or more gateways sensor nodes and the set of data sensors routes packets to one another. The one or more gateway sensor nodes and set of data sensors use one or more routing algorithms to route data among themselves. The routing algorithms may include use of a spanning tree algorithm.

One example implementation of the routing module 326 may be that sensor 305 is data sensor 112 in FIG. 1. Sensor 112 receives data from gateway sensor node 106 and upon processing the received data determines that the data is destined for sensor 114 based on the destination address found in the data. Further, sensor 112 may access a routing table stored in storage bank 315 and, upon examining/processing the routing table, find that destination data sensor 114 is coupled to communication interface 335, for example. Based on such a routing algorithm, routing module 326 may route the data to communication interface 335 accordingly.

The shopper notification module 328 may be in one or embodiments of the sensor 305, including a gateway sensor node or a data sensor, to provide different notification to a shopper's wireless mobile device. In one embodiment, the shopper notification module 328 may be used by a gateway sensor node to query a shopper wireless mobile device upon the shopper entering the retail store. Such a query may be to use the gateway sensor node as a wireless network access point or to download a tag module to the wireless mobile device to receive in-store product information and/or electronic product purchase incentives. Further, the shopper notification module 328 may receive instructions from the shopper wireless mobile device to transmit the tag module. Upon receipt of such instructions, the shopper notification module 328 may cause the sensor 305 to access the tag module (from either the storage bank 315 or from a computer server/database) and have the sensor 305 transmit the tag module to the shopper wireless mobile device, accordingly.

In another embodiment, the shopper notification module 328 may provide a notification message that product information and/or an electronic product purchase incentive can be downloaded to the tagged wireless mobile device. Further, the shopper notification module 328 may receive instructions from the shopper wireless mobile device to transmit the product information or electronic product purchase incentive. Upon receipt of such instructions, the shopper notification module 328 may cause the sensor 305 to access the product information or electronic product purchase incentive (from either the storage bank 315 or from a computer server/database) and have the sensor 305 transmit the tag module to the shopper wireless mobile device, accordingly.

The antenna control module 330 may be used in any embodiment of the sensor (e.g. gateway, calibration sensor, aisle marker sensor, data sensor, etc.). The sensor 305 may include one or more antennas 360 that may include directional antennas as well as omnidirectional antennas. Further, the antenna control module 330 may control the polarization and radiation pattern produced by the directional antennas 360 and control transmit power level of the directional antennas 360 to couple to other devices in a wireless network. Based on proximity and geographic location of the sensor 305, the antenna control module 330 may adjust the radiation pattern of the directional antennas (360) to improve coupling of the sensor to other devices detected on the network. Further, the one or more antennas 360 may include a patch antenna, an array of patch antennas as well, antenna(s) constructed with high dielectric materials. In addition, the one or more antennas 360 can be used in conjunction with other modules implemented by the processor bank 310 to determine an approximate distance of a tagged wireless mobile device or provisioning reader based on a measured received power level from such devices (using techniques known in the art, for example).

Each of the communication interfaces (335-350) may be software or hardware associated in communicating to other devices. The communication interfaces (335-350) may be of different types that include a user interface, USB, Ethernet, WiFi, WiMax, wireless, optical, cellular, Bluetooth Low Energy (BLE), Bluetooth Classic, Bluetooth Smart, ISM, or any other communication interface coupled to a communication network.

In some embodiments, sensor 305 may be a data sensor that generates one or more personal communication networks through the communication interfaces (335-350) using a corresponding directional antenna 360 to communicate with tagged wireless mobile device. Such personal communication networks may be BLE, Bluetooth Smart, and WiFi. Further, in such embodiments, the data sensor 305 may couple to an ISM wireless network through the communication interfaces (335-350) using an omnidirectional antenna 360 to communicate with one or more gateway sensor nodes.

In other embodiments, sensor 305 may be an aisle marker sensor that may generate the personal communication networks through the communication interfaces (335-350) as a data sensor but also includes providing a personal communication network that implements the Bluetooth Classic protocol using either an omnidirectional 360 or directional antenna 360 to couple to a legacy wireless mobile device.

In further embodiments, a sensor 305 may be a calibration sensor that generates one or more wireless networks through the communication interfaces (335-350). Such wireless networks may be BLE and WiFi using an omnidirectional antenna 360 to communicate with a provisioning reader as well as WiFi and ISM using an omnidirectional antenna to communicate with one or more gateways sensor nodes. Further, the calibration sensor 305 may communicate with a GPS system over a wireless network through the GPS interface 365 or through one or more cellular base stations through a cellular interface (335-350).

In additional embodiments, sensor 305 may be a gateway sensor node that generates one or more wireless communication networks through the communication interfaces (335-350) using a corresponding directional antenna 360 or omnidirectional antenna. Such wireless communication networks may be based on WiFi and/or Bluetooth Classic to communicate with a legacy mobile phone. Further, in such embodiments, the gateway sensor node 305 may couple to an ISM wireless network or a WiFi network through the communication interfaces (335-350) using an omnidirectional antenna 360 to communicate with one or more data sensor.

An intra-device communication links 355 and 370 between the processor bank 310, storage device bank 315, modules 317, directional antennas 360 and GPS interface 365 and communication interfaces (335-350) may be one of several types that include a bus or other communication mechanism.

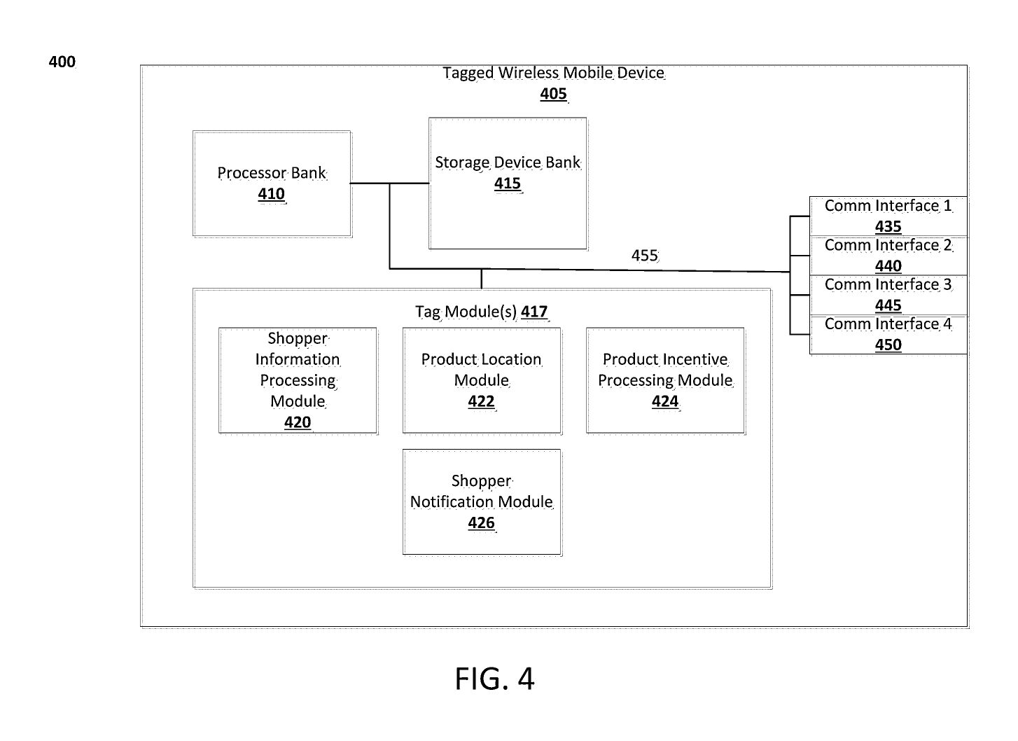

FIG. 4 is a functional block diagram of tagged wireless mobile device 405 used in a system providing a retail store platform for interacting with shoppers in real time in accordance with some embodiments. Such embodiments of tagged wireless mobile device 405 may be used in a system shown in FIG. 1. The device 405 may include several different components such as a processor bank 410, storage device bank 415, one or more software applications, which may be executed by a processor form specifically-configured module devices 417, and one or more communication interfaces (435-450). The modules 417 may be called tag modules or collectively called a tag module in the present disclosure. The processor bank 410 may include one or more processors that may be co-located with each other or may be located in different parts of the device 405. The storage device bank 415 may include one or more storage devices. Types of storage devices may include memory devices, electronic memory, optical memory, and removable storage media. The one or more tag modules 417 may include a shopper information processing module 420, product location module 422, product incentive module 424, and shopper notification module 426. The modules 417 may be implemented by the one or more processors in the processor bank 410.

Tag module(s) generally are downloaded to a smartphone, from an application repository (e.g. Apple App Store, Android App Store, Windows App Store, Third party repositories, etc.) using a link provided by a sensor network, such that it becomes a tagged wireless mobile device 405. Such a tagged wireless mobile device in conjunction with the downloaded tag module(s) may be used by a shopper in a retail store to not only access a WiFi network to obtain Internet access but also receive product information and electronic product purchase incentives that may be redeemable at the retail store POS terminal. The wireless mobile device, whether ‘tagged’ or not, can obtain Internet access using the gateway sensor.

The shopper information processing module 420 may receive shopper input from a user interface of the tagged wireless mobile device 405 (e.g. one of the communication interfaces (435-450)) that includes shopper identification information and shopper loyalty information. Such shopper information may be processed by the shopper information processing module 420 and provided to a gateway sensor node over the one or more communication interfaces (435-450).

In some embodiments, the tagged wireless mobile device 405 may include a product location module 422 that records a product location. That is, when a shopper is browsing a product for possible purchase, the data sensor associated with the product may provide product location information to the tagged wireless mobile device 405. The product location may be location information stored on the data sensor when it is provisioned by a provisioning reader.

The product incentive processing module 424 may receive an electronic product purchase incentive from a data sensor to be redeemed at a POS terminal. Further, the product incentive processing module 424 may store the electronic product purchase incentive in the storage device bank 415. In addition, during checking out at the POS terminal, the product incentive processing module 424 may access the stored electronic product purchase incentive and present such an incentive to the display of the tagged wireless device 405 to be redeemed at a POS terminal.

The shopper notification module 426 receives offer notification from a gateway sensor node to a shopper to provide shopper information or receives a notification from a data sensor to access an electronic product purchase incentive. Further, the shopper notification module 426 receives shopper input (through a user interface) that is relayed to a data sensor which either denies or allows providing the shopper information or denies or allows the downloading of the electronic product purchase incentive to tagged wireless mobile device 405.

Each of the communication interfaces (435-450) may be software or hardware associated in communicating to other devices. The communication interfaces (435-450) may be of different types that include a user interface, USB, Ethernet, WiFi, WiMax, wireless, optical, cellular, or any other communication interface coupled to a communication network. The tagged wireless mobile device may communicate over a communication interface (435-450) with a gateway sensor node over a WiFi network. Further, the tagged wireless mobile device may communicate over a communication interface (435-450) with a gateway sensor node over a wireless network implementing either WiFi, BLE, or Bluetooth Smart protocols.

An intra-device communication links 455 between the processor bank 410, storage device bank 415, tag modules 417, and communication interfaces (435-450) may be one of several types that include a bus or other communication mechanism.

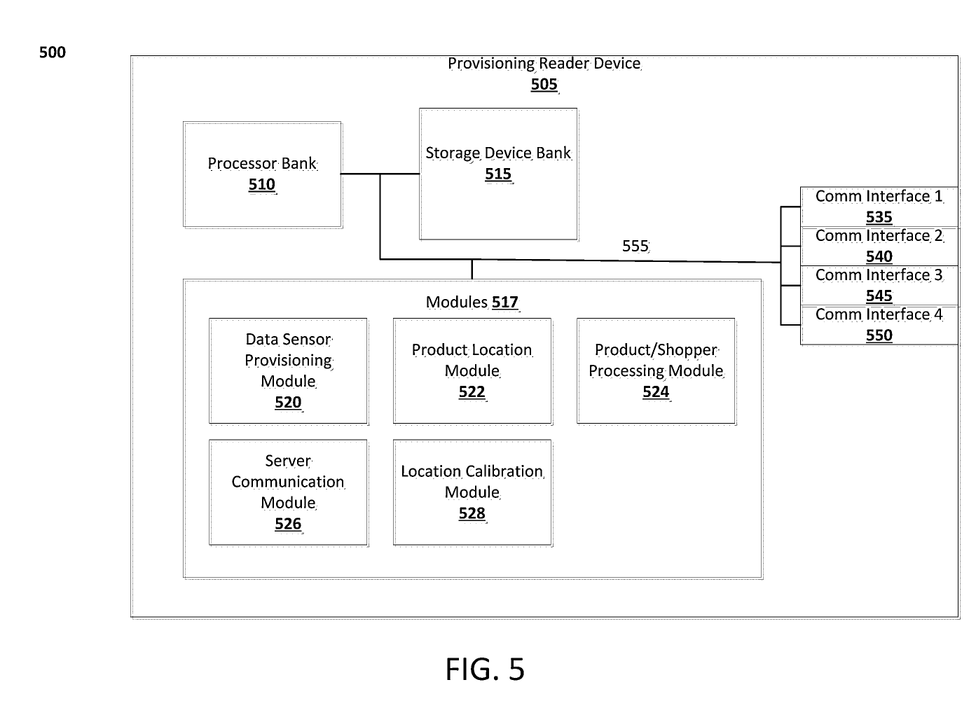

FIG. 5 is a functional block diagram of provisioning reader used in a system providing a retail store platform for interacting with shoppers in real time in accordance with some embodiments. Such embodiments of provisioning reader device 505 may be used in a system shown in FIG. 1 and may be devices that include, but not limited to, smartphones, legacy mobile phones, tablet computers, laptop computers, desktop computers, or any BLE/WiFi enabled computing device. The device 505 may include several different components such as a processor bank 510, storage device bank 515, one or more software applications, that when executed by a processor from specifically-configured module devices 517, and one or more communication interfaces (535-550). The processor bank 510 may include one or more processors that may be co-located with each other or may be located in different parts of the device 505. The storage device bank 515 may include one or more storage devices. Types of storage devices may include memory devices, electronic memory, optical memory, and removable storage media. The one or more modules 517 may include a data sensor provisioning module 520, a product location module 522, product/shopper processing module 524, server communication module 526, location calibration module 528. The modules 517 may be implemented by the one or more processors in the processor bank 510. Further, the modules 517 may be used by the provisioning reader device 505 to provision retail product information (including a retail product identifier) or a sensor location onto one or more data sensors located throughout a retail store as well as collecting a MAC identifier for each data sensor.

The location calibration module 528 communicates with a calibration sensor to determine a starting location for the provisioning reader device 505. The calibration sensor communicates with a GPS system and determines location of the calibration sensor. Thereafter, the calibration sensor provides the location to the provisioning reader device 505. Such a location is used as the starting location of the provisioning reader device 505 and stored in the storage device bank 515.

The data sensor provisioning module 520 is used to provision or configure the data sensor accordingly. Store personnel using the provisioning reader device 505 may travel down aisles of a retail store displaying a number of different products. Each aisle may have several data sensors, each data sensor can be associated with one or more products. Store personnel, during such a provisioning procedure, may travel near to each data sensor to provision or associate the data sensor with one or more products. For example, grocery store personnel may travel down a cereal aisle. Further, cornflakes cereal may be displayed/shelved in the aisle and a data sensor may be located near where the cornflakes cereal is displayed/shelved. Store personnel, during such a provisioning procedure, may have the provisioning reader device 505 communicate with the data sensor and provision or configure the data sensor to be associated with cornflakes cereal. Such a provisioning or configuration may be performed by inputting a retail product identifier into the provisioning reader device 505 (through a user interface which may be one of the communication interfaces 535-550)) and then having the provisioning reader device 505 communicate with the data sensor over a personal communication network (through one of the communication interfaces (535-550) then transmitting the retail product identifier over the personal communication network to the data sensor.

The data sensor provisioning module 520 may further request and receive from the data sensor a MAC identifier over the personal communication network. In addition, the data sensor provisioning module 520 may store the MAC identifier in the storage device bank and associate such MAC identifier with the retail product identifier provisioned onto the data sensor.

The product location module 522 calculates or determines a location of the provision reader device 505 based on the starting location provided by the location calibration module 520 (via the calibration sensor). The product location module 522 may use an accelerometer or other geographic tracking technology known in the art and incorporated into the provisioning reader device (not shown) to determine the current location of the provisioning reader device 505.

Upon provisioning a data sensor with a retail product identifier, collecting the MAC identifier of the data sensor, and storing the MAC identifier with the associated retail product identifier, store personnel may also store a current location of the provisioning reader device 505 (determined by the product location module 522) and associate such current location with the data sensors' MAC identifier and retail product identifier.

The product/shopper processing module 524 may be used to configure or provision an electronic product purchase incentive or other product information on the data sensor using the provisioning reader device 505. Such an incentive/information may be queried by store personnel using the provisioning reader device 505 and then provisioned/transmitted to the data sensor over the personal communication network using the data sensor provisioning module. The data sensor may then store the incentive/information and provide the incentive/information to a shopper (as described herein) in the future. For example, upon provisioning a data sensor with a retail product identifier associated with cornflakes, store personnel may use the product/shopper processing module to access an electronic product purchase incentive associated with cornflakes and transmit such an incentive to the data sensor to be stored therein.

Upon completing provisioning one or more data sensors and storing the MAC identifier, retail identifier, location, and/or incentive associated with each of the one or more data sensors, the store personnel may transmit the stored MAC identifier, retail identifier, location, and/or incentive/information associated with each of the one or more data sensors to a computer server using the server communication module 526. The computer server may then generate a store map using at least a subset of the stored MAC identifier, retail identifier, location, and/or incentive/information associated with each of the one or more data sensors to be used to provide electronic product purchase incentives (or other marketing or promotional materials) to shoppers in the future.

Each of the communication interfaces (535-550) may be software or hardware associated in communicating to other devices. The communication interfaces (535-550) may be of different types that include a user interface, USB, Ethernet, WiFi, WiMax, wireless, optical, cellular, or any other communication interface coupled to a communication network.

The provisioning reader may communicate with a data sensor through one or more communication interfaces (535-550) over a wireless communication network implementing BLE or WiFi. Further, provisioning reader may communicate with gateways sensor node through one or more communication interfaces (535-550) over a wireless communication network implementing either ISM or WiFi protocols. In addition, the provisioning reader may communicate with a computer server through one or more communication interfaces (535-550) over a wireless communication network implementing either WiFi or cellular protocols.

An intra-device communication links 455 and 470 between the processor bank 410, storage device bank 415, tag modules 417, and communication interfaces (435-450) may be one of several types that include a bus or other communication mechanism.

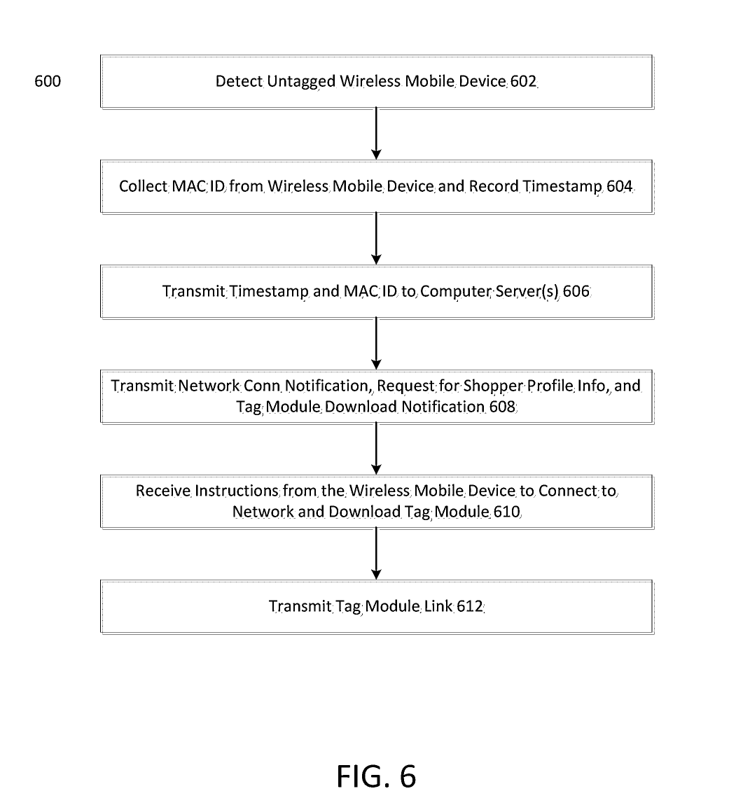

FIG. 6 is a flowchart of a method 600 of providing a retail store platform for interacting with shoppers in real time in accordance with some embodiments. The method may be implemented in a system shown in FIG. 1. The method includes a gateway sensor node detecting an untagged wireless mobile device dynamically over a wireless communication network, as shown in block 602. The method 600 further includes a gateway sensor node collecting a MAC identifier from the wireless mobile device and recording a timestamp, as shown in block 604. In addition, the method 600 includes the gateway sensor node transmitting the timestamp and the MAC identifier of the wireless mobile device to the computer server, as shown in block 606. Moreover, the method 600 includes the gateway sensor node transmitting a network connectivity notification, request for shopper profile information and tag module download offer notification to the wireless mobile device, as shown in block 608. The method 600 also includes the gateway sensor node receiving instructions from the wireless mobile device to couple the wireless mobile device to the wireless communication network and to download a tag module, as shown in block 610. The method 600 includes the gateway sensor node transmitting a link to download the tag module to the wireless mobile device, as shown in block 612. After the tag module has been downloaded by the shopper, the wireless mobile device becomes a tagged wireless mobile device A tagged mobile device can be read by the data sensor using BLE to extract UUID information and MAC ID information. A tagged wireless mobile device can also interact with the primary server using a HTTP session enabling the shopper to request product information and/or electronic product purchase incentives. In one embodiment, the tag module may be stored in a storage device coupled to the computer server such that the tag module is transmitted to the gateway sensor nodes and relayed to the wireless mobile device.

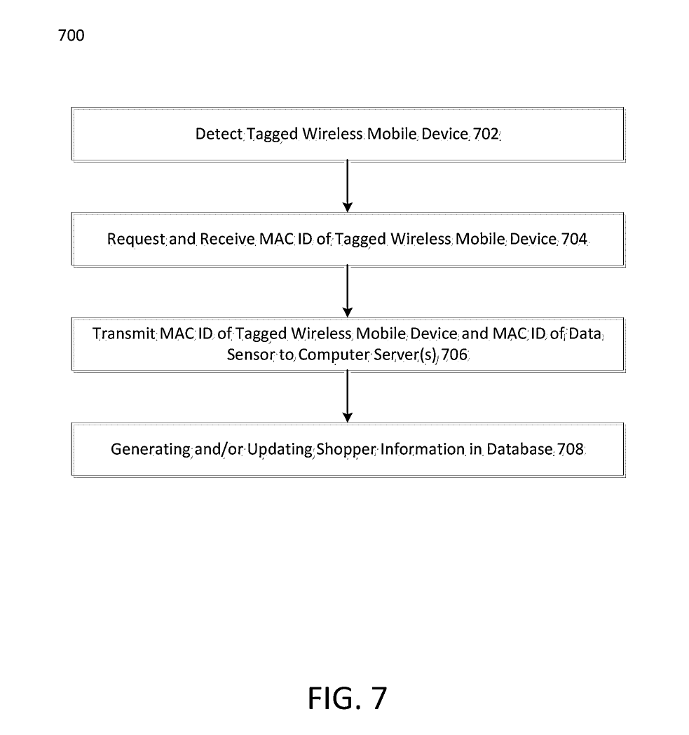

FIG. 7 is a flowchart of a method 700 of providing a retail store platform for interacting with shoppers in real time in accordance with some embodiments. The method may be implemented in a system shown in FIG. 1. The method 700 includes each of a set of data sensors detecting the tagged wireless mobile device over of one or more personal communication networks, as shown in block 702. The method 700 further includes each data sensor requesting and receiving a MAC identifier from the tagged wireless mobile device, as shown in block 704. In another embodiment the UUID may be requested and received from the tagged wireless mobile device. In addition, the method 700 includes each data sensor transmitting the MAC identifier of the tagged wireless mobile device as well as a timestamp and a MAC identifier of data sensor to the computer server, as shown block 706. Moreover, the method 700 includes the computer server generating (if it is the first time such a shopper provided shopper information to the platform) and/or updating shopper information in a database with the received timestamp, the MAC identifier, and/or UUID of the tagged wireless mobile device, a MAC identifier and a retail product identifier of each of the first set of data sensors, as shown in block 708.

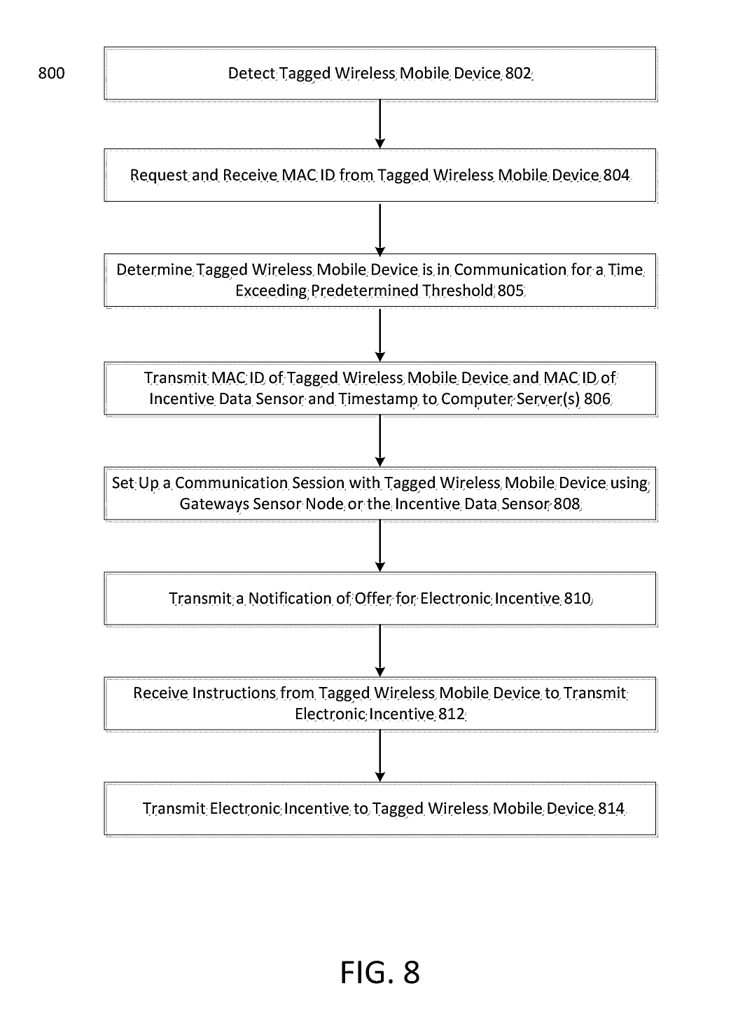

FIG. 8 is a flowchart of a method 800 of providing a retail store platform for interacting with shoppers in real time in accordance with some embodiments. The method may be implemented in a system shown in FIG. 1. The method includes an incentive data sensor detecting a tagged wireless mobile device over of one or more personal communication networks, as shown in block 802. The method 800 further include the incentive data sensor requesting and receiving the MAC identifier from the tagged wireless mobile device, as shown in block 804. In another embodiment the UUID may be requested and received from the tagged wireless mobile device. In addition, method 800 includes the incentive data sensor determining that the tagged wireless mobile device is in communication with the incentive data sensor exceeding a predetermined threshold of time, as shown in block 805. Moreover, the method 800 includes the incentive data sensor transmitting the MAC identifier of the tagged wireless mobile device and the MAC identifier of the incentive data sensor and a timestamp to the computer server, as shown in block 806. The method 800 also includes the computer server set up a communication session with the tagged wireless mobile device using at least one of a gateway sensor node and the incentive data sensor, as shown in block 808. The method 800 further includes the computer server transmitting a notification requesting interaction to the tagged wireless mobile device to offer at least one of the product information and the electronic product purchase incentive, as shown in block 810. In addition, the method 800 includes the computer server receiving one or more instructions from the tagged wireless mobile device to transmit at least one of the product information and the electronic product purchase incentive, as shown in block 812. Moreover, the method 800 includes the computer server transmitting at least one of the product information and the electronic product purchase incentive to the tagged wireless mobile device, as shown in block 814. Such interactions may be conducted over a communication session (e.g. HTTP) between the tagged wireless mobile device and the computer server through a connection to computer server using the data sensor and/or a gateway sensor node.

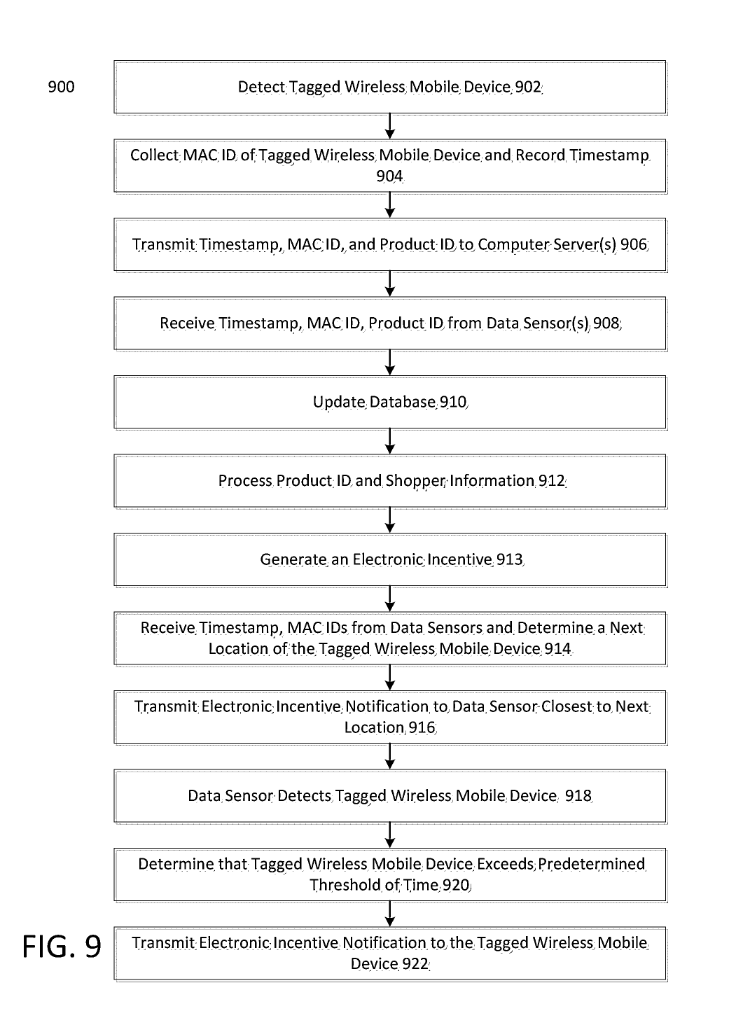

FIG. 9 is a flowchart of a method 900 of providing a retail store platform for interacting with shoppers in real time in accordance with some embodiments. The method may be implemented in a system shown in FIG. 1. The method 900 includes a first set of data sensors detecting a tagged wireless mobile device over one or more personal communication networks wherein the tagging of the wireless mobile device is done dynamically, as shown in block 902. The method 900 further includes the first set of data sensors collecting a MAC identifier, and/or UUID of the tagged wireless mobile device and recording a timestamp, as shown in block 904. In addition, the method 900 includes the first set of data sensors transmitting the timestamp and MAC identifier of tagged wireless mobile device and the retail product identifier of each data sensor to the computer server, as shown in block 906.

Moreover, the method 900 includes the computer server receiving the timestamp, a MAC identifier and a retail product identifier from each data sensor in communication with the tagged wireless mobile device, as shown in block 908. The method 900 also includes the computer server updating a database based on the received timestamp, MAC identifier and retail product identifier from each data sensor, wherein the updating includes generating a new entry in the database of a shopper, as shown in block 910. The method 900 further includes the computer server processing the shopper information including the retail product identifier received from each data sensor, as shown in block 912. In addition, the method 900 includes the computer server generating a product information and/or an electronic product purchase incentive for a product along a future possible path of the shopper based on a store map, as shown in block 913. The method 900 includes the computer server receiving timestamp and MAC identifier, and/or UUID of the tagged wireless mobile device from a second set of data sensors and receive a MAC identifier and retail product identifier for each of the second set of data sensors as well as determining next location of the tagged wireless mobile device based on the received timestamp and MAC identifier, and/or UUID of the tagged wireless mobile device and the MAC identifier and retail product identifier for each of the second set of data sensors, as shown in block 914. The method 900 also includes the computer server transmitting product information and/or the electronic product purchase incentive notification to a data sensor associated with the product and closest the next location of the wireless mobile device, as shown in block 916.

The method 900 further includes the data sensor at the next location detecting the tagged wireless mobile device, as shown in block 918. In addition, the method 900 includes the data sensor determining that the tagged device has been present within the range of the personal network exceeding a predetermined threshold of time, as shown in block 920. Moreover, data sensor may transmit the device identifier of the tagged wireless mobile device, the MAC identifier of the data sensor and a timestamp to the computer server and the computer server may set up a communication session with the tagged wireless mobile device using at least one of a gateway sensor node and the data sensor (sensor closest to next location of tagged wireless device may be a data sensor (110-120) or a gateways sensor node (106-107) shown in FIG. 1. Moreover, the method 900 includes the data sensor transmitting the product information and/or electronic product purchase incentive notification to the tagged wireless mobiles device, as shown in block 922. Such interactions may be conducted over a communication (e.g. HTTP) session between the tagged wireless mobile device and the computer server through a connection to computer server using the data sensor and a gateway sensor node.

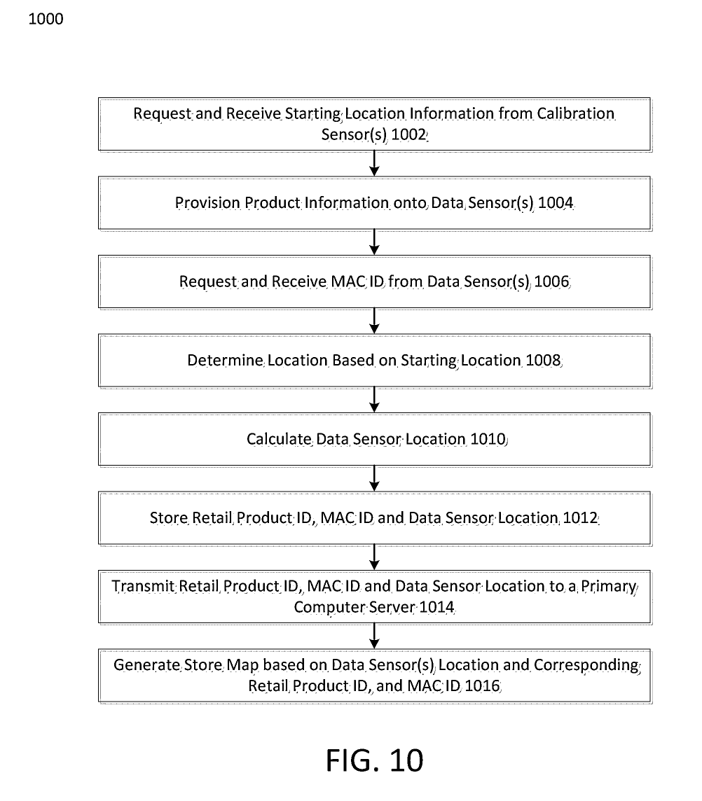

FIG. 10 is a flowchart of a method 1000 of providing a retail store platform for interacting with shoppers in real time in accordance with some embodiments. The method may be implemented in a system shown in FIG. 1. The method 1000 includes a provisioning reader requesting and receiving a starting location information from the one or more calibration sensors over the calibration communication network, as shown in block 1002. The method 1000 further includes the provisioning reader provisioning product information including retail product identifier onto the one or more data sensors, as shown in block 1004. In addition, the method 1000 includes the provisioning reader requesting and receiving MAC identifier from each of the one or more data sensors, as shown in block 1006. Moreover, the method 1000 includes the provisioning reader determining a location of the provisioning reader based on the processing of the starting location information received from the one or more calibration sensors, as shown in block 1008. The method 1000 also includes the provisioning reader calculating data sensor location based on the location of the provisioning reader, as shown in block 1010. The method 1000 further includes the provisioning reader storing the retail product identifier, MAC identifier of each data sensor, and data sensor location for each data sensor on the memory device of the provisioning reader, as shown in block 1012. In addition, the method 1000 includes the provisioning reader transmitting the retail product identifier, MAC address, and data sensor location for each of the one or more data sensors to the computer server over a wireless communication network, as shown in block 1014. The method 1000 also includes the computer server dynamically generating a store map based on the received one or more data sensor location and corresponding product identifier and MAC identifier, as shown in block 1016.

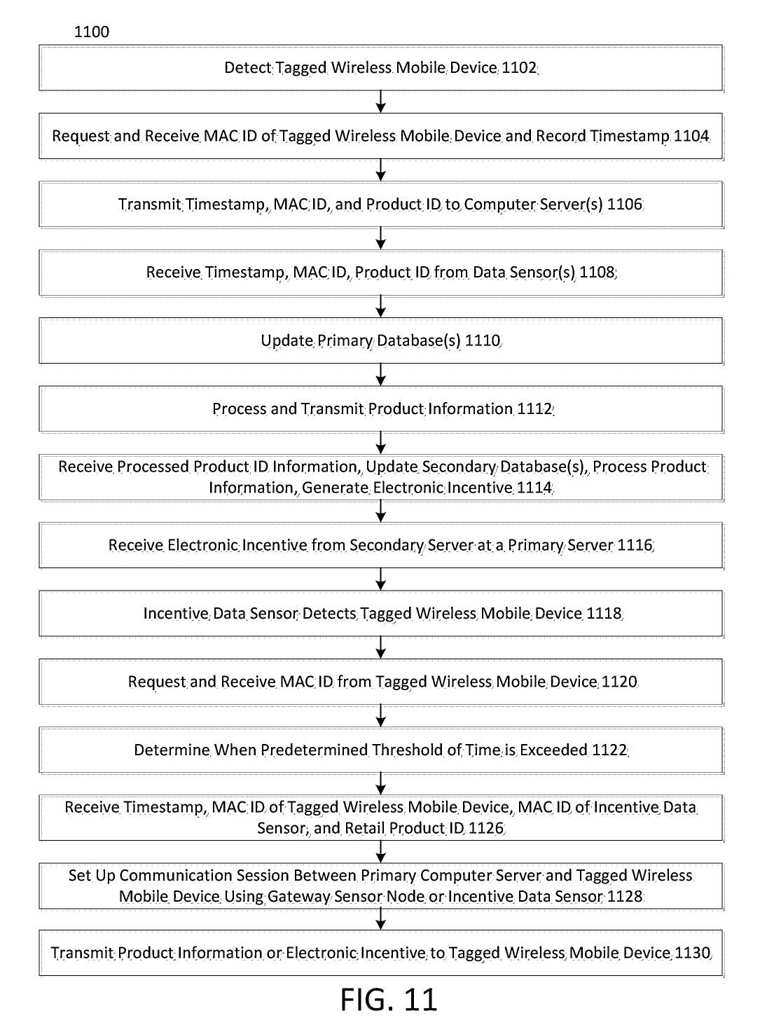

FIG. 11 is a flowchart of a method 1100 of providing a retail store platform for interacting with shoppers in real time in accordance with some embodiments. The method may be implemented in a system shown in FIG. 1. The method 1100 includes a first set of data sensors detecting a tagged wireless mobile device over the one or more personal communication networks, as shown in block 1102. The tagging of the wireless mobile device is done dynamically. The method 1100 further includes the first set of data sensors requesting and receiving MAC identifier, and/or UUID of the tagged wireless mobile device and recording a timestamp, as shown in block 1104. In addition, the method 1100 includes the first data sensors transmitting timestamp and MAC identifier, and/or UUID of tagged wireless mobile device and the retail product identifier of each data sensor to the primary computer server, as shown in block 1106. Moreover, the method 1100 includes the primary computer server receiving timestamp, MAC identifier and retail product identifier from each data sensor in communication with the tagged wireless mobile device, as shown in block 1108. The method 1100 also include the one or more primary computer databases updating a primary database based on the received timestamp, MAC identifier and product identifier from each data sensor, as shown in block 1110. The method 1100 further includes the primary computer server processing and transmitting the retail product identifier to generate the retail product information and shopper information, as shown in block 1112.

In addition, the method 1100 includes the secondary computer server receiving the processed product information and shopper information and updating the secondary database based on the received information (the update includes generating a new entry in the database of a shopper), processing the product information as well as generating a secondary purchase incentive, product information, and/or analytics based on the processed product information, as shown in block 1114. Moreover, the secondary computer server may transmit the secondary purchase incentive to the primary computer server and the primary computer server may receive such secondary purchase incentive.

The method 1100 also includes the primary computer server receiving timestamp and MAC identifier of the tagged wireless mobile device from a second set of data sensors and receives the MAC identifier, and/or UUID and product identifier for each of the second set of data sensors, as shown in block 1116. The method 1100 further includes the incentive data sensor detecting the tagged wireless mobile device over one or more personal communication networks, as shown in block 1118. In addition, the method 1100 includes request and receive the MAC identifier from the tagged wireless mobile device, as shown in block 1120.

In addition, the method 1100 includes the data sensor determining whether the tagged wireless mobiles device has been within the range of the data sensor's personal communication network for a time exceeding a predetermined threshold, as shown in block 1122. The method 1100 includes the primary computer server setting up a communication session with the tagged wireless mobile device using at least one of a gateway sensor node and the incentive data sensor, as shown in block 1128. Further, the method may include the primary computer server transmitting a notification to the tagged wireless mobile device requesting interaction to offer at least one of the product information and the electronic product purchase incentive and the primary computer server receiving one or more instructions from the tagged wireless mobile device to transmit at least one of the product information and the electronic product purchase incentive. The method 1100 includes the primary computer server transmitting at least one of the product information and the electronic product purchase incentive to the tagged wireless mobile device, as shown in block 1130. Such interactions may be conducted over a communication (e.g. HTTP) session between the tagged wireless mobile device and the computer server through a connection to primary computer server using the data sensor and a gateway sensor node. The primary computer server may update the primary database and also the secondary database using the communication link between the primary computer server and the secondary computer server.

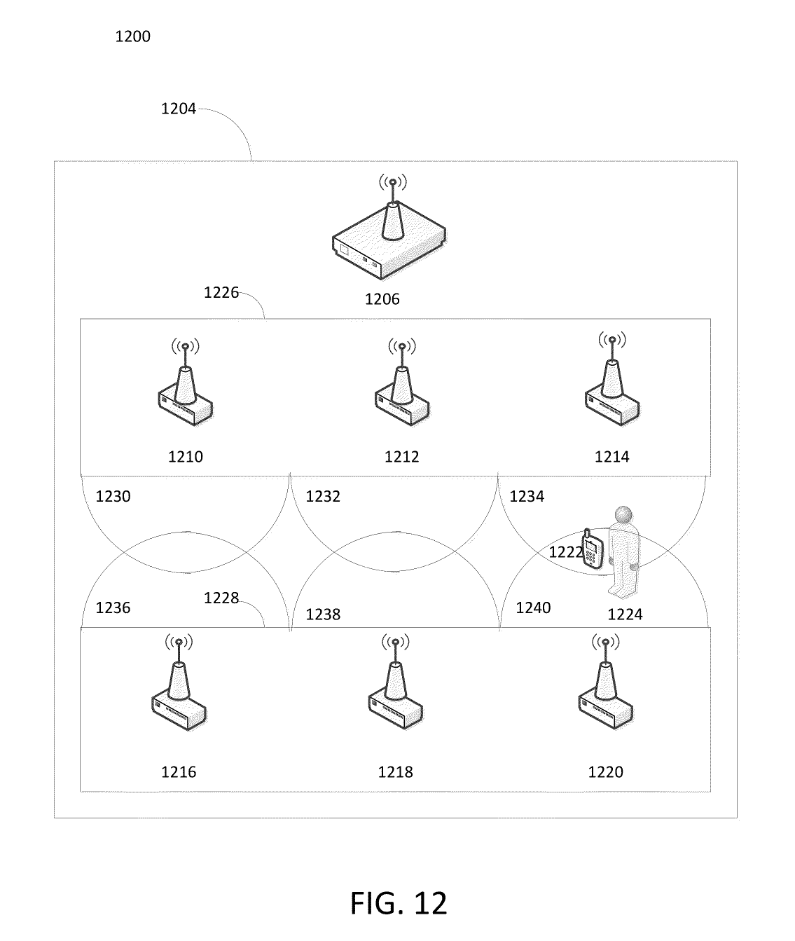

FIG. 12 is a functional block diagram of a system 1200 providing a retail store platform for interacting with shoppers in real time in accordance with some embodiments. FIG. 12 has some of the same devices shown in FIG. 1. That is, the system 1200 includes a set of data sensors (1210-1220) located throughout a retail store 1204. Some of the data sensors (1210-1214) may be located in one aisle 1226 while some other data sensors (1216-1220) may be located in another aisle 1228 of many such aisles in retail store 1204. Each of the data sensors (1210-1220) are coupled two a set of gateway sensors nodes (1206-1207) over a communication network. In some embodiments such a communication network may be a wireless network while in other embodiments the communication network may be a land-line network. The communication networks described with respect to FIG. 12 (and in the present disclosure generally) may be, but not limited to, a wireless network, landline network, local area network (LAN), wide area network (WAN), satellite network, and Internet.

Each of the data sensors includes one or more directional antennas that generate a personal communication network (e.g. Bluetooth Low Energy) to communicate with a mobile phone 1222. The one or more directional antennas of each data sensor have a radiation pattern (1230-1240) whose range, polarization, and shape may be configured. The radiation pattern generated by the directional antenna is used to detect presence of a shopper's tagged wireless mobile device 1222 when it is within the radiation pattern of the directional antenna. The data sensor (1210-1220) can track the presence of the shopper 1224 in front of the corresponding product shelf to detect if the shopper has exceeded a predetermined threshold of time, triggering an offer of product information and/or electronic product purchase incentive to the shopper 1224.

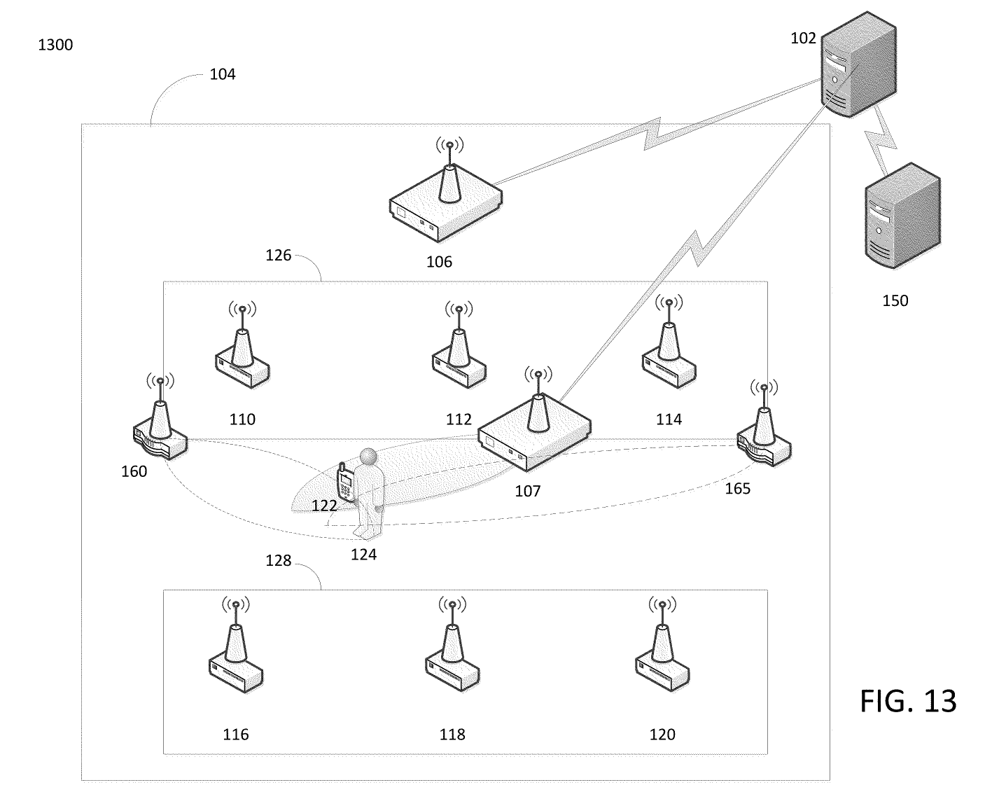

FIG. 13 is a functional block diagram of a system 1300 providing a retail store platform for interacting with shoppers in real time in accordance with some embodiments. The system 1300 includes a set of data sensors (110-120) located throughout a retail store 104. Some of the data sensors (110-114) may be located in one aisle 126 while some other data sensors (116-120) may be located in another aisle 128. Each of the data sensors (110-120) are coupled to a set of gateway sensors nodes (106-107) over a communication network. In some embodiments, such a communication network may be a wireless network while in other embodiments the communication network may be a land-line network. Further, the gateway sensor nodes (106-107) may be coupled to one or more primary computer servers (102) over a communication network. Moreover, the system 1300 may include aisle sensor markers (160-165) which are data sensors with additional functionality or specialized data sensors as described herein. The aisle sensor markers (160-165) can be used to track the presence of a shopper 124 with a legacy phone 122.

Further, the system 100 includes one or more primary computer servers 102 coupled to the one more gateway sensor nodes (106-107) over a communication network. Such a network may be, but not limited to, a wireless network, landline network, local area network (LAN), wide area network (WAN), satellite network, WiFi, and Internet. Further, the one or more computer servers 102 may be coupled to a mobile phone carrier computer server 150 over another communication network or a direct link.

The communication networks described with respect to FIG. 13 (and in the present disclosure generally) may be, but not limited to, a wireless network, landline network, local area network (LAN), wide area network (WAN), satellite network, and Internet.

In one embodiment, shopper 124 may enter the retail store 104 with legacy mobile phone 122 (i.e. not a smartphone). In such an embodiment, a gateways sensor node (106-107) may scan for such legacy phone 122 using WiFi technology or other type of personal communication network technology. Upon detecting the legacy phone 122, the gateway sensor node (106-107) collects the MAC identifier and timestamp from the legacy phone 122. The MAC identifier and timestamp are sent by the gateways sensor nodes (106-107) to the primary computer server 102. Further, the primary computer server 102 sends a request to the computer server 150 of the carrier of the legacy phone to exchange text messages with the legacy phone 122. By the primary computer server 102 providing the carrier server 150 with the MAC identifier of the legacy phone 122, the carrier server 150 can look up the mobile phone number for legacy phone 122 based on the MAC identifier. The carrier server 150 can then send, upon a request of the primary computer server 102, a text message requesting whether the shopper 124 would like to receive electronic product purchase incentives as well as for shopper information and loyalty card information. If the shopper affirmatively replies to such a request and/or provides shopper information and loyalty card information (via text message to the primary computer server 102 through the carrier server 150), the primary computer server 102 may provide electronic product purchase incentives by providing incentive codes in text messages to the legacy phone 122 through the carrier computer server 150. If the shopper denies the request, the primary computer server 102 generates an anonymous profile based on the collected MAC identifier and timestamp of the legacy phone 122. The electronic product purchase incentive can also be sent as a picture using text messaging, SMS or MMS.

In either scenario, the legacy phone is tracked using the aisle sensor markers (160-165). Such aisle sensor markers (160-165) have antennas that provide wider radiation patterns than the directional antennas of the data sensors (110-120) described herein. Further, the gateway sensor nodes (106-107) can also track the legacy phone 122 of the shopper 124. In one embodiment, aisle marker sensors (160-165) as well as gateway sensor node 107, each detect legacy phone 122. By measuring the received power level from the legacy phone 122, direction of arrival (DOA), each sensor (107, 160, 165) can determine, through triangulation, each approximate distance from the legacy phone 122 (e.g. using an inverse square relationship between power level and distance). Each sensor (107, 160, 165) may transmit a received power level and/or DOA to the primary computer server 102 to determine a location of the legacy phone based on triangulation algorithms known in the art. Further, the primary computer server 102 may determine the location information and provide incentive codes in a text message to the legacy phone for products in aisles already visited or for products in aisles the primary computer server 102 predicts the shopper will travel through.

In the present disclosure, in some embodiments, the incentive transmitting sensor (e.g. incentive data sensor) may be a data sensor (110-120) or a gateway sensor node (106-107) in FIG. 1. In addition, a computer server may set up a communication (e.g. HTTP, email, etc.) session between the computer server and a tagged wireless mobile device through either a data sensor (110-120) or a gateway sensor node (106-107) in FIG. 1 to transmit product information and/or an electronic product purchase incentive.

Further, in the present disclosure the term device identifier may be used to describe the MAC identifier or UUID of a device or any combination. The term device identifier may be interchanges with MAC ID and the term device identifier may be interchanged with UUID.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Further, the embodiments disclosed may be implemented individually or in combination with other embodiments or aspects thereof.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system, comprising:
(a) a first communication network;
(b) a computer server coupled to the first communication network and the computer server coupled to a database;
(c) one or more gateway sensor nodes coupled to the computer server using the first communication network;
(d) a second communication network and a third communication network coupled to the one or more gateway sensor nodes;
(e) a wireless mobile device;
(f) wherein the one or more gateway sensor nodes are configured to: (i) detect the wireless mobile device dynamically over the second communication network; (ii) collect a device identifier from the wireless mobile device and record a timestamp; (iii) transmit the timestamp and the device identifier of the wireless mobile device to the computer server; (iv) transmit a network connectivity offer notification, request for shopper profile information and tag module download offer notification to the wireless mobile device; (v) receive instructions from the wireless mobile device to couple the wireless mobile device to the second communication network and to download a tag module; (vi) transmit a link to the wireless mobile device to download the tag module such that the wireless mobile device becomes a tagged wireless mobile device when the tag module is downloaded;
(g) one or more personal communication networks;
(h) a first set of data sensors coupled to the one or more gateway sensor nodes over the third communication network, each of the first set of data sensors having, a media access control (MAC) identifier, a processor and a memory device, and each of the first set of data sensor generating a corresponding personal communication network using a directional antenna;
(i) wherein each data sensor is configured to: (i) detect the tagged wireless mobile device over of the one or more personal communication networks; (ii) request and receive the device identifier from the tagged wireless mobile device; (iii) transmit the device identifier of the tagged wireless mobile device, the MAC identifier of data sensor and a timestamp to the computer server;
(j) wherein the computer server is configured to at least one of generate and update shopper information in the database with the received timestamp and the device identifier of the tagged wireless mobile device, a MAC identifier and a retail product identifier of each of the first set of data sensors.

2. The system of claim 1, the system further comprising an incentive data sensor coupled to the one or more gateway sensor nodes over the second communication network, the incentive data sensor having, a MAC identifier, a processor and a memory device, and incentive data sensor generates a corresponding personal communication network,
wherein the incentive data sensor is configured to: (i) detect the tagged wireless mobile device over one or more personal communication networks; (ii) request and receive the device identifier from the tagged wireless mobile device; (iii) determine that the tagged wireless mobile device is in communication with the incentive data sensor exceeding a predetermined threshold of time; (iv) transmit the device identifier of the tagged wireless mobile device, the MAC identifier of the incentive data sensor and a timestamp to the computer server;
wherein the computer server is configured to: (i) set up a communication session with the tagged wireless mobile device using at least one of a gateway sensor node and the incentive data sensor; (ii) transmit a notification to the tagged wireless mobile device requesting interaction to offer at least one of the product information and the electronic product purchase incentive.

3. The system of claim 2, wherein the computer server is further configured to:
(i) receive one or more instructions from the tagged wireless mobile device to transmit at least one of the product information and the electronic product purchase incentive;
(ii) transmit at least one of the product information and the electronic product purchase incentive to the tagged wireless mobile device.

4. A system, comprising:
(a) a first communication network;
(b) a database storing customer data, retailer information, product information including one or more product incentives in computer media
(c) a computer server coupled to the first communication network and the database;
(d) one or more gateway sensor nodes coupled to the computer server using the first communication network;
(e) a second communication network coupled to the one or more gateway sensor nodes;
(f) one or more personal communication networks;
(g) a first set of data sensors coupled to the one or more gateway sensor nodes over the second communication network, each of the first set of data sensors having a processor, a memory device and retail product identifier stored on the memory device, and each of the first set of data sensors generating a corresponding personal communication network using a directional antenna wherein each data sensor is configured to: (i) detect a tagged wireless mobile device over the one or more personal communication networks wherein the tagging of the wireless mobile device is done dynamically; (ii) collect timestamp and a device identifier of the tagged wireless mobile device; (iii) transmit timestamp and the device identifier of tagged wireless mobile device and the retail product identifier of each data sensor to the computer server;
(h) the computer server is configured to: (i) receive timestamp, media access control (MAC) identifier and retail product identifier from each data sensor in communication with the tagged wireless mobile device; (ii) update shopper information in the database based on the received timestamp, MAC identifier and retail product identifier from each data sensor, wherein the update includes generating a new entry in the database of a shopper; (iii) process the shopper information including the retail product identifier from each data sensor; (iv) generate an electronic product purchase incentive for a product along a future possible path of the shopper based on a store map; (v) receive timestamp and device identifier of the tagged wireless mobile device from a second set of data sensors and receive a MAC identifier and retail product identifier for each of the second set of data sensors; (viii) determine next location of the tagged wireless mobile device based on the received timestamp and device identifier of the tagged wireless mobile device and the MAC identifier and retail product identifier for each of the second set of data sensors; (ix) transmit an electronic product purchase incentive notification to a data sensor associated with the product and closest to the next location of the wireless mobile device;
(i) wherein the data sensor receiving the electronic product purchase incentive notification is configured to: (i) detect the tagged wireless mobile device; (ii) determine that the tagged wireless mobile device has been present within the range of the personal network exceeding a pre-configured threshold of time; (ii) transmit the device identifier of the tagged wireless mobile device, the MAC identifier of the data sensor and a timestamp to the computer server;
(j) wherein the computer server is configured to: (i) set up a communication session with the tagged wireless mobile device using at least one of a gateway sensor node and the data sensor; (ii) transmit a notification to the tagged wireless mobile device requesting interaction to offer at least one of the product information and the electronic product purchase incentive.

5. The system of claim 4, wherein the computer server is further configured to request a shopper to query for additional product and retail store information to the tagged wireless mobile device.

6. The system of claim 5, wherein the one or more gateway sensor nodes includes one or more omnidirectional antennas.

7. The system of claim 6, wherein:
(a) the one or more gateway sensor nodes communicate among each other and with the wireless mobile device over the second communication network using the one or more omnidirectional antennas;
(b) the second communication network is a WiFi network.

8. The system of claim 6, wherein:
(a) the one or more gateway sensor nodes communicate with the first set of data sensors and the incentive data sensor over the third communication network using the one or more omnidirectional antennas;
(b) the third communication network is an ISM network.

9. The system of claim 4 wherein the first set of data sensors, the second set of data sensors and the data sensor closest to the next location of the tagged wireless mobile device each includes one or more omnidirectional antennas and one or more directional antennas.

10. The system of claim 9, wherein:
the first set of data sensors, the second set of data sensors and the data sensor closest to the next location of the tagged wireless mobile device communicate with the tagged wireless mobile device over the one or more personal communication networks using the one or more directional antennas;
wherein the one or more personal communication networks is at least one of a Bluetooth Low energy (BLE) network, Bluetooth Smart network, and a WiFi network.

11. The system of claim 4, wherein the one or more gateway sensor nodes, the first set of data sensors, the second set of data sensors and the data sensor closest to the next location of the tagged wireless mobile device are part of a sensor network.

12. The system of claim 11, wherein the sensor network includes point-to-point links interconnecting each of the one or more gateway sensor nodes, and each of the first set of data sensors, the second set of data sensors and the data sensor closest to the next location of the tagged wireless mobile device.

13. The system of claim 11, wherein the sensor network includes at least one master data sensor associated with one or more slave data sensors such that the at least one master data sensor routes data between the one or more gateways sensor nodes and the one or more slave data sensors.

14. The system of claim 11, wherein the sensor network includes at least one master data sensor associated with, and dynamically daisy chained to, one or more slave data sensors such that the at least one master data sensor routes data between the one or more gateways sensor nodes and the one or more slave data sensors.

15. The system of claim 11, wherein:
the sensor network includes the one or more gateways sensor nodes in a gateway sensor mesh network and the first set of data sensors, the second set of data sensors and the data sensor closest to the next location of the tagged wireless mobile device in a data sensor mesh network such that the gateways sensor mesh network and the data sensor mesh network are interconnected.

16. The system of claim 11, wherein the one or more gateway sensor nodes, the first set of data sensors, the second set of data sensors and the data sensor closest to the next location of the tagged wireless mobile device use one or more routing algorithms.

17. The system of claim 16, wherein the routing algorithms include use of a spanning tree algorithm.

18. The system of claim 4, wherein each of the first set of data sensors, the second set of data sensors and the data sensor closest to the next location of the tagged wireless mobile device includes one or more batteries to provide power and that the corresponding data sensor receives one or more power duty cycling commands to conserve power from the one or more gateways sensor nodes.

19. The system of claim 18, wherein the power duty cycling commands includes a sleep command and an awake command such that the corresponding data sensor has a power duty cycle of a power duty time period, a sleep time period that is a portion of the power duty time period, and an awake time period that is a portion of the power duty time period.

20. A method comprising:
(i) detecting, by each of a first set of data sensors, a tagged wireless mobile device over one or more personal communication networks wherein the tagging of the wireless mobile device is done dynamically;
(ii) collecting, by each of the first set of data sensors, a device identifier of the tagged wireless mobile device and recording a timestamp;
(iii) transmitting, by each of the first set of data sensors, timestamp and device identifier of tagged wireless mobile device and the retail product identifier of each data sensor to the computer server;
(iv) receiving timestamp, device identifier and retail product identifier from each data sensor in communication with the tagged wireless mobile device by a computer server;
(v) updating shopper information in the database based on the received timestamp, device identifier and retail product identifier from each data sensor by the computer server, wherein the updating includes generating a new entry in the database of a shopper;
(vi) processing, by the computer server, the shopper information including the retail product identifier from each data sensor;
(vii) generating at least one of a product information and an electronic product purchase incentive for a product along a future possible path of the shopper based on a store map by the computer server;
(viii) receiving, by the computer server, timestamp and device identifier of the tagged wireless mobile device from a second set of data sensors and receive a media access control (MAC) identifier and retail product identifier for each of the second set of data sensors;
(ix) determining next location of the tagged wireless mobile device based on the received timestamp and device identifier of the tagged wireless mobile device and the MAC identifier and retail product identifier for each of the second set of data sensors;
(x) transmitting the at least one of product information and the electronic product purchase incentive notification to a data sensor associated with the product and closest the next location of the wireless mobile device;
(xi) detecting the tagged wireless mobile device by the data sensor receiving the electronic product purchase incentive notification;
(xii) determining, by the data sensor receiving the electronic product purchase incentive notification, that the tagged wireless mobile device has been present within the range of the personal network exceeding a predetermined threshold of time;
(xiii) transmitting, by the data sensor receiving an electronic product purchase incentive notification, the device identifier of the tagged wireless mobile device, the MAC identifier of the data sensor and a timestamp to the computer server;
(xiv) setting up, by the computer server, a communication session with the tagged wireless mobile device using at least one of a gateway sensor node and the data sensor receiving the electronic product purchase incentive notification;
(xv) transmitting, by the computer server, a notification to the tagged wireless mobile device requesting interaction to offer at least one of the product information and the electronic product purchase incentive.

21. The method of claim 20, further comprising requesting, by a computer server, a shopper to download additional product and retail store information to the tagged wireless mobile device.

22. A computer server device, comprising:
(a) a database;
(b) a computer server coupled to the database, the computer server having:
(i) a first communication interface to communicate with a gateway sensor node;
(ii) one or more processors;
(iii) one or more storage devices coupled to the one or more processor;
(iv) one or more modules, executed by the one or more processors, configured to: (a) receive timestamp, device identifier and retail product identifier from each of a first set of data sensors in communication with the tagged wireless mobile device; (b) update shopper information in the database based on the received timestamp, device identifier and retail product identifier from each data sensor, wherein the update includes generating a new entry in the database of a shopper (c) process the shopper information including the retail product identifier from each data sensor; (d) generate an electronic product purchase incentive for a product along a future possible path of the shopper based on a store map; (e) receive timestamp and device identifier of the tagged wireless mobile device from a second set of data sensors and receive a media access control (MAC) identifier and retail product identifier for each of the second set of data sensors; (f) determine a next location of the tagged wireless mobile device based on the received timestamp and device identifier of the tagged wireless mobile device and the MAC identifier and retail product identifier for each of the second set of data sensors; (g) transmit an electronic product purchase incentive notification to a data sensor associated with the product and closest the next location of the wireless mobile device; (h) set up a communication session with the tagged wireless mobile device using at least one of a gateway sensor node and the data sensor; (i) transmit a notification to the tagged wireless mobile device requesting interaction to offer at least one of the product information and the electronic product purchase incentive.

23. A system, comprising:
(a) a first communication network;
(b) a computer server coupled to the first communication network;
(c) one or more gateway sensor nodes coupled to the computer server using the first communication network;
(d) a second communication network coupled to the one or more gateway sensor nodes;
(e) one or more calibration sensors, each calibration sensor having a calibration communication network;
(f) one or more data sensors, each data sensor having one or more personal communication networks using a directional antenna;
(g) a provisioning reader having a provisioning module;
(h) wherein the provisioning reader is dynamically coupled, on demand, to the one or more calibration sensors over the calibration communication network, coupled to the one or more gateway sensor nodes over the second communication network and coupled to the one or more data sensors over the one or more personal communication networks, the provisioning reader having a processor and a memory device, the provisioning reader configured to: (i) request and receive starting location information from the one or more calibration sensors over the calibration communication network; (ii) provision product information, including a retail product identifier, onto the each of the one or more data sensors; (iii) request and receive a media access channel (MAC) identifier from each of the one or more data sensors; (iv) determine location of the provisioning reader based on processing of the starting location information received from the one or more calibration sensors; (v) calculate data sensor location based on the location of the provisioning reader while the provisioning reader is in detection proximity of the data sensor; (vi) store a retail product identifier, MAC identifier of each data sensor, and data sensor location for each data sensor on the memory device of the provisioning reader; (vii) transmit the retail product identifier, MAC address, and data sensor location for each of the one or more data sensors to the computer server, over the second communication network, the one or more gateway sensor nodes; and the first communication network;
(j) wherein the computer server dynamically generates a store map based on the received one or more data sensor location and corresponding retail product identifier and MAC identifier.

24. The system of claim 23, wherein the provisioning reader communicates with the one or more data sensors over the one or more personal communication networks using the one or more communication interfaces and one or more omnidirectional antennas wherein the one or more personal communication networks are networks that use a Bluetooth Low Energy protocol.

25. The system of claim 23, wherein the provisioning reader is a device selected from the group consisting of a smartphone, tablet computer, laptop computer, desktop computer, and any BLE/WiFi enabled computing device, coupled to the provisioning module.

26. A method, comprising:
(i) requesting and receiving, by a provisioning reader, a starting location information from one or more calibration sensors over a calibration communication network, while in detection proximity of the one or more calibration sensors, wherein the provisioning reader is dynamically coupled to the one or more calibration sensors over the calibration communication network, capable of being coupled to one or more gateway sensor nodes over a second communication network and capable of being coupled to the one or more data sensors over one or more personal communication networks, the provisioning reader having a processor and a memory device;
(ii) provisioning, by the provisioning reader, product information, including a retail product identifier, onto the each of the one or more data sensors;
(iii) requesting and receiving, by the provisioning reader, a media access channel (MAC) identifier from each of the one or more data sensors;
(iv) determining, by the provisioning reader, location of the provisioning reader based on processing of the starting location information received from the one or more calibration sensors while in detection proximity of a data sensor;
v) calculating, by the provisioning reader, the data sensor location based on the location of the provisioning reader;
(vi) storing, by the provisioning reader, the retail product identifier, MAC identifier of each data sensor, and data sensor location for each data sensor on the memory device of the provisioning reader;
(vii) transmitting, by the provisioning reader, the retail product identifier, MAC address, and data sensor location for each of the one or more data sensors to the computer server, over the second communication network, the one or more gateway sensor nodes; and a first communication network;
(viii) dynamically generating, by the computer server, a store map based on the received one or more data sensor location and corresponding retail product identifier and MAC identifier.

27. A provisioning reader device, comprising:
one or more processors,
one or more storage devices coupled to the one or more processors;
one or more modules, executed by the one or more processors, the modules configured to: (i) request and receive starting location information from the one or more calibration sensors over the calibration communication network, while in detection proximity of the one or more calibration sensors; (ii) provision product information, including a retail product identifier, onto the each of the one or more data sensors; (iii) request and receive a media access channel (MAC) identifier from each of the one or more data sensors; (iv) determine location of the provisioning reader based on processing of the starting location information received from the one or more calibration sensors; (v) calculate data sensor location based on the location of the provisioning reader; (vi) store a retail product identifier, MAC identifier of each data sensor, and data sensor location for each data sensor on the memory device of the provisioning reader; (vii) transmit the retail product identifier, MAC address, and data sensor location for each of the one or more data sensors to the computer server, over the second communication network, the one or more gateway sensor nodes; and the first communication network such that the computer server dynamically generates a store map based on the received one or more data sensor location and corresponding retail product identifier and MAC identifier.

28. The device of claim 27, wherein the provisioning reader communicates with the one or more data sensors over the one or more personal communication networks using the one or more communication interfaces and one or more omnidirectional antennas, wherein the one or more personal communication networks, generated by the one or more data sensor, are networks that use a Bluetooth Low Energy protocol.

29. The device of claim 27, wherein the provisioning reader communicates with the one or more gateways sensor nodes over the second communication network using the one or more communication interfaces and one or more omnidirectional antennas wherein the second communication network is a WiFi network.

30. The device of claim 27, wherein the provisioning reader communicates with the one or more calibration sensors over the calibration communication network using the one or more communication interfaces and one or more omnidirectional antennas wherein the calibration communication network is based on at least one of Bluetooth Low Energy and a WiFi network.

31. The device of claim 27, wherein the provisioning reader is a device selected from the group consisting of a smartphone, legacy mobile phone, tablet computer, laptop computer, desktop computer, and any BLE/WiFi enabled computing device, coupled to the provisioning module.

32. A system, comprising:
(a) a server network;
(b) a secondary computer server coupled to the server network and secondary database, the secondary computer server and secondary database associated with a retail partner;
(c) a first communication network;
(d) a primary computer server coupled to the first communication network and primary database;
(e) one or more gateway sensor nodes coupled to the one or more computer servers using the first communication network;
(f) a second communication network coupled to the one or more gateway sensor nodes;
(g) one or more personal communication networks;
(h) a first set of data sensors coupled to the one or more gateway sensor nodes over the second communication network, each of the first set of data sensors having a media access control (MAC) identifier, processor, a memory device and a retail product identifier stored on the memory device, and each of the first set of data sensors generating one or more personal communication networks using a directional antenna; wherein each data sensor is configured to: (i) detect a tagged wireless mobile device over the one or more personal communication networks wherein the tagging of the wireless mobile device is done dynamically; (ii) request and receive the device identifier from the tagged wireless mobile device; (iii) transmit timestamp and device identifier of tagged wireless mobile device and a media access control (MAC) identifier and the retail product identifier of each data sensor to the primary computer server; wherein:
(a) the primary computer server is configured to: (i) receive the timestamp and the device identifier of the tagged wireless mobile device and MAC identifier and retail product identifier for each data sensor in communication with the tagged wireless mobile device; (ii) update the primary database based on the received timestamp, device identifier of the tagged wireless mobile device, and MAC identifier and retail product identifier for each data sensor (iii) process the retail product identifier to generate the retail product information and shopper information; (iv) transmit the retail product information and the shopper information to the secondary computer server;
(b) the secondary computer server is configured to: (i) receive the processed product information and shopper information; (ii) update the secondary database based on the received product information and shopper information, wherein the update includes generating a new entry in the database of a shopper; (iii) process the product information and shopper information; (iii) generate a secondary purchase incentive and analytics based on the processed product information and shopper information for a product along a future possible path of the shopper based on a store map; (iv) transmitting the secondary purchase incentive to primary computer server;
(c) the primary computer server is configured to: (i) receive the secondary purchase incentive from the secondary computer server; wherein an incentive data sensor is configured to: (i) detect the tagged wireless mobile device over one or more personal communication networks; (ii) request and receive the device identifier from the tagged wireless mobile device; (iii) determine that the tagged wireless mobile device is in communication with the incentive data sensor exceeding a predetermined threshold of time; (iv) transmit the device identifier of the tagged wireless mobile device, the MAC identifier of the incentive data sensor and a timestamp to the primary computer server;
(d) the primary computer server is configured to: (i) receive timestamp and device identifier of the tagged wireless mobile device from an incentive data sensor and receive the MAC identifier and retail product identifier for the incentive data sensor; (ii) set up a communication session with the tagged wireless mobile device using at least one of a gateway sensor node and the incentive data sensor; (iii) transmit a notification to the tagged wireless mobile device requesting interaction to offer at least one of the product information and the electronic product purchase incentive; (iv) receive one or more instructions from the tagged wireless mobile device to transmit at least one of the product information and the electronic product purchase incentive; (v) transmit at least one of the product information and the electronic product purchase incentive to the tagged wireless mobile device.

33. A method, comprising:
(i) detecting, by each of a first set of data sensors, a tagged wireless mobile device over one or more personal communication networks wherein the tagging of the wireless mobile device is done dynamically and wherein the first set of data sensors are coupled to one or more gateway sensor nodes over a second communication network, each of the first set of data sensors having a processor, a memory device and a retail product identifier stored on the memory device, and each of the first set of data sensors generating one or more personal communication networks using a directional antenna;
(ii) collecting, by each of a first set of data sensors, a device identifier of the tagged wireless mobile device and recording a timestamp;
(iii) transmitting, by each of a first set of data sensors, the timestamp and device identifier of tagged wireless mobile device and a MAC identifier and the retail product identifier of each data sensor to a primary computer server;
(iv) receiving, by a primary computer server, the timestamp and the device identifier of the tagged wireless mobile device and MAC identifier and retail product identifier for each data sensor in communication with the tagged wireless mobile device;
(v) updating, by primary computer server, a primary database based on the received timestamp, device identifier of the tagged wireless mobile device, and MAC identifier and retail product identifier for each data sensor;
(vi) processing, by primary computer server, the retail product identifier to generate the retail product information and shopper information;
(vii) transmitting, by primary computer server, the retail product information and the shopper information to the secondary computer server;
(viii) receiving, by the secondary computer server, the processed product information and shopper information;
(ix) updating, by the secondary computer server, a secondary database based on the received product information and shopper information, wherein the update includes generating a new entry in the database of a shopper;
(x) processing, by the secondary computer server, the product information and shopper information;
(xi) generating, by the secondary computer server, a secondary purchase incentive, product information, and analytics based on the processed product information and shopper information for a product along a future possible path of the shopper based on a store map;
(xii) transmitting, by the secondary computer server, the secondary purchase incentive to primary computer server;
(xiii) receiving, by the primary computer server, the secondary purchase incentive from the secondary computer server;
(xiv) receiving, by the primary computer server, the secondary purchase incentive from the secondary computer server;
(xv) detecting, by an incentive data sensor, the tagged wireless mobile device over one or more personal communication networks;
(xvi) requesting and receiving, by an incentive data sensor, the device identifier from the tagged wireless mobile device;
(xvii) determining, by an incentive data sensor, that the tagged wireless mobile device is in communication with the incentive data sensor exceeding a predetermined threshold of time;
(xviii) transmitting, by an incentive data sensor, the device identifier of the tagged wireless mobile device, the MAC identifier of the incentive data sensor and a timestamp to the primary computer server;
(xix) receiving, by the primary computer server, timestamp and device identifier of the tagged wireless mobile device from an incentive data sensor and receive the MAC retail product identifier for the incentive data sensor;
(xx) setting up, by the primary computer server, a communication session with the tagged wireless mobile device using at least one of a gateway sensor node and the incentive data sensor;
(xxi) transmitting, by the primary computer server, a notification to the tagged wireless mobile device requesting interaction to offer at least one of the product information and the electronic product purchase incentive; (iv) receive one or more instructions from the tagged wireless mobile device to transmit at least one of the product information and the electronic product purchase incentive; (v) transmit at least one of the product information and the electronic product purchase incentive to the tagged wireless mobile device.

34. A secondary computer server device, comprising:
(a) a server communication interface;
(b) one or more processors coupled to the communication interface and a secondary database;
(c) one or more storage devices coupled to the one or more processors;
(d) one or more modules, executed by the one or more processors, the one or more modules configured to: (i) receive processed product information and shopper information from a primary computer server; (ii) update the secondary database based on the received product information and shopper information; (iii) process the product information and shopper information; (iii) generate a secondary purchase incentive and analytics based on the processed product information and shopper information, wherein the update includes generating a new entry in the database of a shopper; (iv) transmitting the secondary purchase incentive to the primary computer server.
